(19) United States
(12) Patent Application Publication
(10) Pub. No.: US 2021/0246048 A1
(43) Pub. Date: Aug. 12, 2021

(54) DEVELOPMENT OF LOW-COST ACTIVATED CARBON FOR REMOVAL OF VOCS AND PHARMACEUTICALS FROM RESIDENTIAL DRINKING WATER

(71) Applicant: University of Kentucky Research Foundation, Lexington, KY (US)

(72) Inventor: Stephen M. Lipka, Lexington, KY (US)

(21) Appl. No.: 17/049,613

(22) PCT Filed: Apr. 24, 2019
(86) PCT No.: PCT/US2019/028898

§ 371 Date: Oct. 22, 2020

Related U.S. Application Data
(60) Provisional application No. 62/661,698, filed on Apr. 24, 2018.

(51) Int. Cl. C02F 1/28; B01J 20/20

(52) U.S. Cl. CPC C02F 1/283; B01J 20/20; C02F 2101/322; B01J 2220/4875; B01J 2220/62; B01J 2220/485

(57) ABSTRACT

The present invention relates to systems incorporating, and uses of, hydrothermally dehydrated carbonaceous products, particularly from waste sources, that when activated provide for effective filters in water streams. The activated particles have high microporosity and provide an improved and affordable approach to decontamination of water sources. The invention further includes preparation of such systems, including steps of hydrothermal dehydration, optional carbonization, and physical activation.

### RELATED APPLICATIONS

This application claims priority to U.S. Provisional Patent Application 62/661,698, filed Apr. 24, 2018, the contents of which are hereby incorporated by reference in its entirety.

### TECHNICAL FIELD

This document relates generally to producing activated carbonaceous materials from waste materials that are effective in removing contaminants from a water source.

### BACKGROUND

Activated carbon is well understood in the art to act effectively as a filter. In large part, activated carbons function by trapping contaminants based on its very porous nature and high surface area. An ongoing area of development has been approaches to improve the porosity of activated carbon to increase absorption of contaminants.

Typically, improvements to activated carbon have yielded a slight improvement but a significant price increase due to the high levels of processing and selection. To identify a product with improved porosity over commercial activated carbons that can be generated inexpensively reflects a marked improvement in the field. The present invention has achieved such. Identified herein are methods to produce and use an activated carbonaceous source that is demonstrated to out-perform commercially activated carbons. Moreover, the materials produced are generated from waste materials and involve a series of inexpensive steps to achieve such.

### SUMMARY

In accordance with the purposes and benefits described herein, an invention concerning systems and methods for decontaminating water are described. The methods include approaches to prepare a filtering material and methods to use such in connection with a water source. Also contemplated are systems featuring the filtering materials.

The filtering materials of the present invention are prepared by a step of hydrothermal dehydration of a carbonaceous material. The materials can advantageously include waste materials, such as bourbon stillage, spent grains and discarded husks. Following hydrothermal dehydration, the new materials can be further carbonized and then activated to provide a highly microporous material.

The activated materials can then be contained and introduced into a water stream, such as being restrained by porous screens, or solidified into a porous solid material that can be restrained by apparent means. Ideally, a water source will flow through on opening end and depart at a distal end with the flow having to pass through the activated materials. The denser the activated materials are packed, the more the water flow must proceed through the microporous network of the materials. Alternatively, water can be incubated with the activated materials and allowed to circulate with through the activated materials in a closed system for a period of time, such that sufficient decontamination can occur.

The activated materials of the present invention can be use in isolation or in concert with other filtering materials. For example, use with a macroporous filtering material will allow for differing stages of decontamination, allowing more discreet materials to be captured in the microporous network of the materials of the present invention.

The drawings and descriptions should be regarded as illustrative in nature and not as restrictive.

### BRIEF DESCRIPTION OF THE DRAWING FIGURES

FIG. 1 shows SEM images of hydrothermally prepared spent beer grain (left) and bourbon stillage (right).

FIG. 2 shows a schematic of the synthetic process for making activated carbons from bio-waste.

FIG. 3 shows nitrogen BET pore size distribution for spent beer grain samples (a) Carb 771, (b) Carb 773, (c) Carb 774 and (d) Carb 776.

FIG. 4 shows nitrogen BET pore size distribution for bourbon stillage sample carb 78.

FIG. 5 shows nitrogen BET pore size distribution for GE activated carbon samples (a) GS06 and (b) GS07.

FIG. 6 shows particle size distribution for sample Carb 783 prepared from bourbon stillage.

FIG. 7 shows pore size distributions for GE carbon samples. (incremental pore volume axis kept constant for comparison).

FIG. 8 shows mass loss of 3 different routes.

FIG. 9 shows incremental pore volume/pores size distribution for activated carbons prepared from bourbon stillage after carbonization at various temperatures.

FIG. 10 shows pore size distributions for GE activated carbon samples and Carb 801. (Incremental pore volume axis kept constant for comparison).

FIG. 11 shows GC mass spectrum data for chloroform spiked DI water after exposure to various activated carbon samples.

FIG. 12 shows TGA plots for all sample tested.

FIG. 13 shows pore size distribution for GS09 before and after heat treatment.

FIG. 14 shows chloroform standardization curve (wide range).

FIG. 15 shows chloroform standardization curve (narrow range).

FIG. 16 shows a schematic of a testing protocol used for conducting chloroform adsorption experiments with activated carbon.

FIG. 17 shows chloroform adsorption capacity for AquaCarb® 1230AWC.

FIG. 18 shows chloroform adsorption capacity for GS06.

FIG. 19 shows chloroform adsorption capacity for GS07.

FIG. 20 shows chloroform adsorption capacity comparison for ACs after 5 hours of exposure.

FIG. 21 shows chloroform adsorption capacity comparison for ACs after 24 hours of exposure.

FIG. 22 shows Freundlich isotherms for the adsorption of trichloromethane onto three activated carbons.

FIG. 23 shows Freundlich isotherms for the adsorption of trichloromethane onto activated carbons.

FIG. 24 shows Freundlich isotherms for the adsorption of trichloromethane onto activated carbons prepared from bourbon stillage.

FIG. 25 shows Freundlich isotherms for the adsorption of trichloromethane onto activated carbons prepared from bourbon stillage.

FIG. 26 shows Freundlich isotherms for the adsorption of trichloromethane onto activated carbons.

FIG. 27 shows Freundlich isotherms for the adsorption of trichloromethane onto selected activated carbons prepared from bourbon stillage.

FIG. 28 shows Freundlich isotherms for the adsorption of trichloromethane onto selected activated carbons prepared from commercial carbohydrates.

FIG. 29 shows Freundlich Isotherm parameters for adsorption of trichloromethane in water on activated carbon samples prepared from mixtures of precursor/additives.

FIG. 30 shows 24 hour chloroform reduction for activated carbons.

FIG. 31 shows 24 hour chloroform reduction for selected activated carbons prepared from bourbon stillage.

FIG. 32 shows 24 hour chloroform reduction for activated carbons prepared from commercial carbohydrates.

FIG. 33 shows 24 hour chloroform reduction for activated carbons prepared from mixtures of precursor/additives.

FIG. 34 shows 24 hour chloramine reduction for selected activated carbons.

### DETAILED DESCRIPTION

The present invention concerns application of hydrothermally dehydrated waste products as suitable improvements over activated carbon for water filtration.

Prior work has identified that hydrothermal dehydration (“hydrothermal dehydration”, “hydrothermal synthesis” (“HTS”) and “hydrothermal carbonization” (HTC) may be used interchangeably and refer to a method of preparing carbon particles) of saccharides provided a carbon-based material that could function effectively in electrodes, despite the presence of hydrogen and oxygen in the materials utilized. U.S. Pat. Nos. 9,670,066 and 9,440,858 (incorporated herein by reference in their entirety) set forth descriptions on preparing hydrothermally dehydrated products. U.S. Pat. No. 9,670,066 further contemplates that such products can substitute in some other industrial roles where activated carbon is applied, such as lubrication and de-ionization.

The present invention has continued the analysis of hydrothermally dehydrated products, in particular, hydrothermally dehydrated waste products. The waste products assessed herein include bourbon stillage, spent grain from brewing (such as in the production of beer) and discarded husks, such as those from coconuts. However, waste products for the purposes of the invention are not limited to these three, but indeed should be considered to include discarded or unwanted materials wherein carbon is the primary material, along with hydrogen and oxygen. Trace amounts of other elements or minerals can also be included in the starting or precursor materials subjected to the hydrothermal treatment (dehydration) (such as nitrogen, sulfur, transition metals, alkalai metals, alkalai earth metals, post-transition metals, silicon, phosphorous, chlorine, bromine, and germanium (to name a few)).

Hydrothermal dehydration confers a physical change to the product. This is demonstrated in U.S. Pat. No. 9,670,066, for example, where saccharides are demonstrated to effectively function in battery systems following this process. Hydrothermal dehydration includes the processing steps of placing a starting material in a pressure vessel, heating the pressure vessel, and allowing the starting material to read in the heated pressure vessel for a period of time, i.e., dwell time. In some embodiments, additives may be added to such a precursor solution, the additives including at least one additive selected from the group consisting of potassium hydroxide, sodium hydroxide, ammonium hydroxide, cysteine, phloroglucinol, ammonium phosphate, ammonium hydroxide, boric acid, lead nitrate, melamine, sodium lauryl sulfate, ammonium tetraborate, methane sulfonic acid, ethylene glycol, hydroquinone, catechol, resorcinol, ammonium bicarbonate, oxalic acid, citric acid, acetic acid, acrylic acid, ammonium chloride, ammonium sulfate, polyethylenimine, and urea. The dwell time may be at least about 5 minutes, at least about 10 minutes, at least about 15 minutes, at least about 30 minutes, at least about 1 hour, at least about 5 hours, or at least about 15 hours. The dwell time may be less than about 150 hours, less than about 120 hours, less than about 90 hours, less than about 80 hours, less than about 70 hours, less than about 60 hours, or less than about 50 hours. This includes dwell times of about 5 minutes to about 150 hours, about 10 minutes to about 120 hours, about 15 minutes to about 90 hours, about 30 minutes to about 80 hours, about 1 hour to about 70 hours, about 5 hours to about 60 hours, and about 15 hours to about 50 hours. The maximum pressure in the pressure vessel may be less than about 350 psi, less than about 325 psi, less than about 300 psi, less than about 275 psi, or less than about 250 psi. In some embodiments, the minimum pressure in the pressure vessel may be at least about 70 psi, at least about 80 psi, at least about 90 psi, at least about 100 psi, or at least about 110 psi. This includes pressure ranges from about 70 psi to about 350 psi, about 80 psi to about 325 psi, about 90 psi to about 300 psi, about 100 psi to about 275 psi, and about 110 psi to about 250 psi. U.S. Pat. No. 9,670,066 further describes how one skilled in the art can tune the diameter of hydrothermally produced particles.

The produced particles can be further optionally treated to assist further in filtering contaminants. As described in some examples below, treating with nitrogenous sources (ammonia gas or hydrothermally processing precursors that contain nitrogen compounds, e.g., distillery waste) provides a mechanism by which resulting particles containing levels of chemically bound surface nitrogen which can further reduce contaminants such as chloramine.

The present invention has identified a further, unexpected, physical property offered by hydrothermal dehydration, namely that it produces a material with high microporosity throughout. This microporosity component can surpass that seen or currently available in traditional activated carbons. This feature allows for a different and novel filtering material for treating water. The different porosity profile offers a different material that can be used alone or in concert with other filtering materials to better trap (e.g., adsorb) contaminants through chemisorption and/or physisorption mechanisms.

The process of preparing the filtering materials comprises a series of steps, some of which are optional and/or can be achieved through variations. The starting materials comprise waste materials or by-products of other industrial processes. As set forth below, these include bourbon stillage, spent grains and spent husks. These materials are then hydrothermally dehydrated to create a “green” carbon rich product. This initial product can then optionally be carbonized, before then being activated to provide an activated hydrothermally dehydrated material.

Activation of the green carbon products can be achieved through any means known in the art. Those skilled in the art will, however, appreciate that a physical activation is preferred over a chemical activation, particularly in view of the end use so as to avoid leaching or unintentional contamination of a water supply. Particles may be physically activated by heating in the presence of ammonia gas, ammonium hydroxide/water vapor, deionized water (steam activation), nitrogen, or carbon dioxide at temperatures from about 600° C. to about 1100° C. and soak times of about zero minutes to about two hours. Particles may be physically activated using a combination of the methods. Physical activation can be conducted to produce particles with microporosities ranging from 80 to 99% with corresponding mesoporosities ranging from 19 to 1%.

Activation of the hydrothermally dehydrated waste products provides a collection of particles with high microporosity. Porosities which can a combination of microporosities ranging from 80 to 99% with corresponding mesoporosities ranging from 19 to 1%. For example, the activated materials may comprise at least 90% microporosity, including 91%, 92%, 93%, 94%, 95%, 96%, 97%, 98%, 99%, 99.9% and 100%. The materials can have a meso porosity of less than 15%, including 14%, 13%, 12%, 11%, 10%, 9%, 8%, 7%, 6%, 5%, 4%, 3%, 2%, 1%, 0.1% or less. Macroporosity can be less than 5%, including 4%, 3%, 2%, 1%, 0.1% or less.

Following activation, the processed waste materials can further be prepared to effectively allow water to flow therethrough to provide for capture of contaminants therein. The further processing may include affixing particles together (e.g., using a binder material) to form a solid water permeable shape, or to be packed together and held in place through permeable screens, such that a water flow would pass through a bed of the particles without allowing the particles to leach into such flow. Alternatively, the activated materials can be incubated with a water source in a closed system, ideally with a pump or other means present to circulate the water around the activated materials. Such incubation can proceed for any amount of time, ideally until a desired level of decontamination is achieved.

Water filtration can occur by controlling flow over and through the activated hydrothermally dehydrated particles. The slower the flow or the more exposure to activated particles allows for greater contaminant capture. The filtration process can proceed by direction a flow or stream of water to pass over the activated particles. The water then filters through the collection of particles and then exits. Those skilled in the art will appreciate that the less space between the packed particles there exists requires water flow to go more through the porous particles and can further negatively increase pressure in the system. Therefore, packing density, while also affecting water flow and pressure, can also affect contaminant removal.

The activated particles can act as filters for a water flow either alone or in concert with other materials. As set forth below, the activated particles have a distinct microporosity profile that varies from that of activated carbon. While in some instances it may be worthwhile to rely solely on the activated particles of the present invention, in other instances, introduction of other materials may be of use. For example, in highly contaminated water streams, a higher macroporosity material may provide a general initial decontamination step, allowing for smaller contaminants to be then captured by the particles of the present invent. As such, other filtering materials may be considered either upstream of the filter stage of the present invention, or in the same filtering stage (e.g. packed together with the particles of the present invention).

The present invention thus provides methods for preparing a water filtering system, methods of using such, and a water purification system itself. The methods for preparing the water purification system comprise preparing activated hydrothermally dehydrated particles from waste products and packaging such into a device/cartridge/assembly that can receive a flow of water at one end and expel water at a further distal end. Use of the system comprises introducing the activated particles into a water stream in a manner such that the water stream passes through the particles and exits. The system itself needs to have a means for introducing a water flow and a means for allowing the water flow to depart once having come in contact with the activated particles.

The activated materials can be placed into systems to filter water, either by incubation and/or flow through. The activated materials thus need a means to be held or restrained from joining a water flow and leaching out. Such approaches can include physical restraints, such as by porous screens to retain the activated materials, or by further processing the materials into a solid porous shape, such as by applying heat and/or pressure or adding an adhesive. Solid shapes can then be retained straightforwardly. Those skilled in the art will appreciate that forming a solid material from the activated materials

The approaches herein described can be further adapted as evidenced in the examples to accommodate additional needs within a water filtering system or methodology thereof.

### Examples

Initial Data

Two precursor materials were obtained from a brewing and distilling company in Kentucky; bourbon stillage from Wilderness Trail Distillery, Danville, Ky. and spent beer grain from Country Boy Brewing, Lexington, Ky. The bourbon stillage consisted of a mixture of spent grain and liquid, the majority in liquid form. The spent beer grain consisted entirely of wet solid material.

Hydrothermal processing. Wet spent grain beer waste was placed into a 14 L glass liner to fill approximately a 4 L volume. DI water was added to the solid spent grain to form a 4 L mixture. For the bourbon stillage, 4 L of waste was used placed directly into the 14 L glass liner and used as-is. In each case, the glass liner was placed into a Parr stainless steel pressure vessel and heated to 200° C. for 5 hours after which the solid product was collected by filtration.

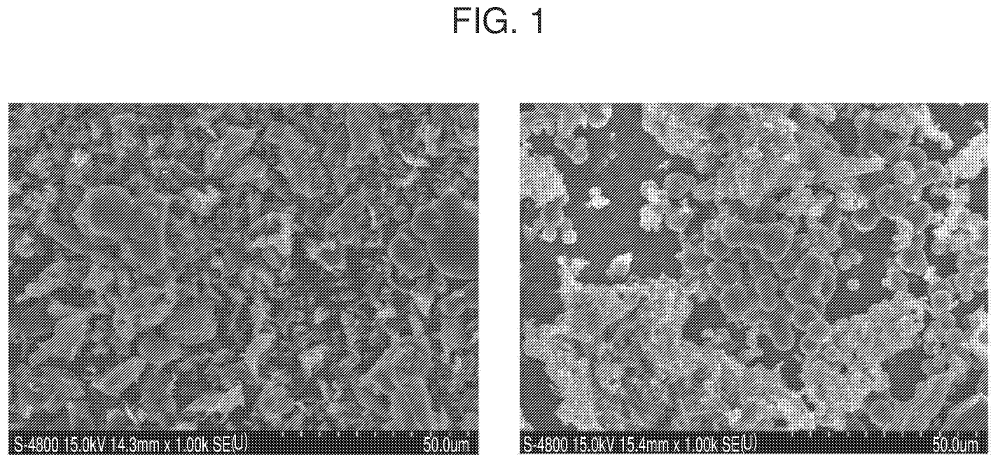

After the hydrothermal process, the as-synthesized carbon was dried overnight in an oven at 120° C. The morphology of the as-synthesized carbon was investigated by SEM. FIG. 1 shows the resultant product from the spent beer grain and bourbon stillage after the hydrothermal process. The solid spent beer grain showed mechanical breakdown during the hydrothermal process which resulted in irregularly shaped carbon. During the hydrothermal process, the bourbon stillage precursor underwent dehydration and formed a brown/black carbon rich solid product which was spherical in nature.

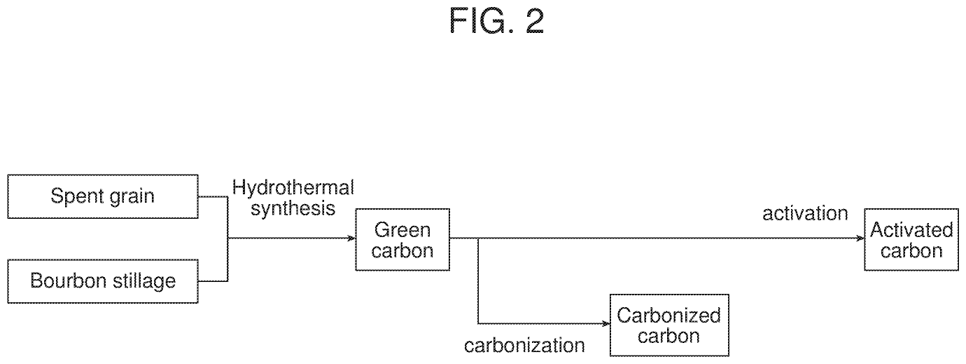

Carbonization, activation and surface area analysis. As shown in FIG. 2, after the hydrothermal processing step, two routes were used to prepare activated carbon. As-synthesized carbon (or green carbon) was either activated directly or carbonized first then activated. The purpose of the extra carbonization step was to stabilize the green carbon and burn off excessive organics which might affect the activation step. Standard carbonization was conducted in a tube furnace at 500° C. under the flow of nitrogen. Two activation processes were used; steam activation and CO2 activation which are the most commonly used physical activation schemes. Nitrogen BET adsorption/desorption isotherms was collected on the samples and used to determine surface area, total pore volume (TVP) and pore size distribution of the activated carbons. The nitrogen BET results are summarized in Table 1. The spent beer grain was obtained in advance of the bourbon stillage and therefore more processing/activation experiments were conducted on this material.

TABLE 1
Nitrogen BET isotherm results for activated carbons prepared from bourbon and beer waste.

| | Hydrothermal | | | BET | TVP | Micro | Meso | Macro |
|---|---|---|---|---|---|---|---|---|
| Precursor | Synthesis | Carbonization | Activation | (m²/g) | (cc/g) | porosity | porosity | porosity |
| Beer | 200 C. 5 H | None | Steam | 1158 | 0.4825 | 82.0 | 14.8 | 3.2 |
| waste | | | 850 C. | | | | | |
| Carb 771 | 200 C. 5 H | 500 C. | Steam | 992 | 0.4095 | 91.2 | 6.2 | 2.6 |
| Beer | | | 850 C. | | | | | |
| waste | | | | | | | | |
| Carb 773 | 200 C. 5 H | 500 C. | Steam | 730 | 0.3055 | 95.4 | 2.1 | 2.5 |
| Beer | | | 800 C. | | | | | |
| waste | | | | | | | | |
| Carb 776 | 200 C. 5 H | 500 C. | CO2 | 833 | 0.5475 | 9.6 | 90.1 | 0.3 |
| Beer | | | 900 C. | | | | | |
| waste | | | | | | | | |
| Carb 774 | 200 C. 5 H | 500 C. | Steam | 1152 | 0.4621 | 89.2 | 9.2 | 1.6 |
| Bourbon | | | 850 C. | | | | | |
| waste | | | | | | | | |
| Carb 783 | | | | | | | | |

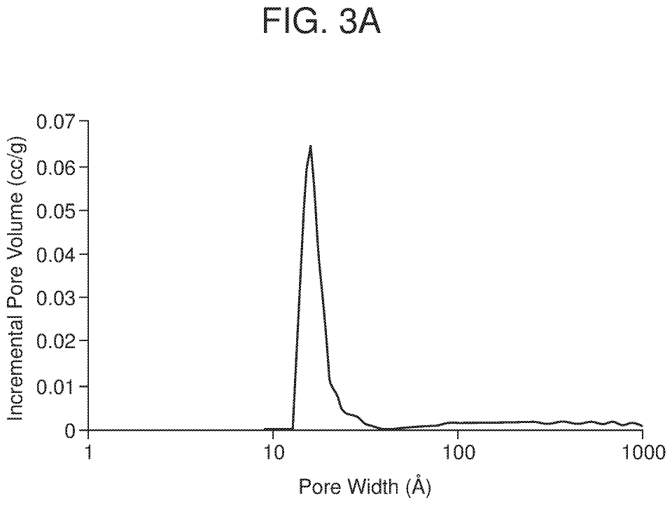

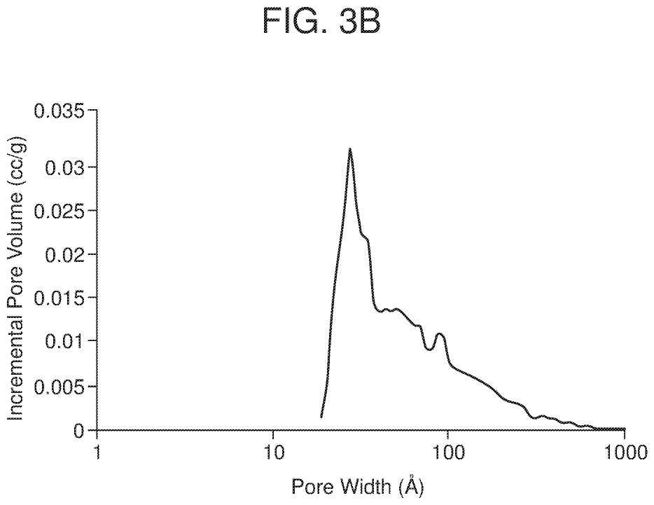

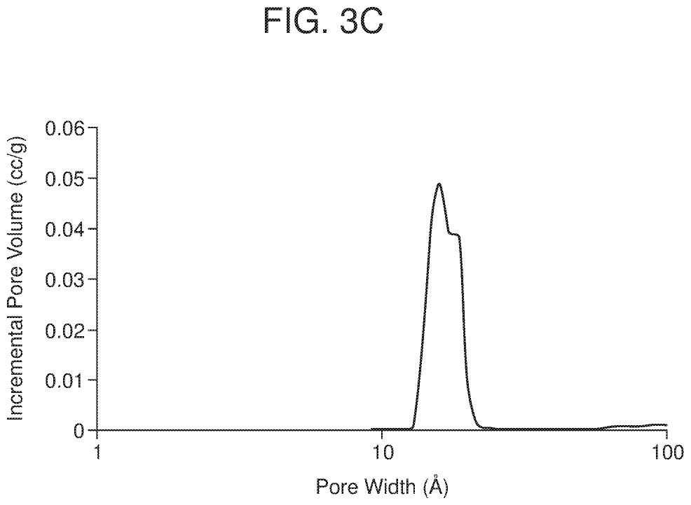

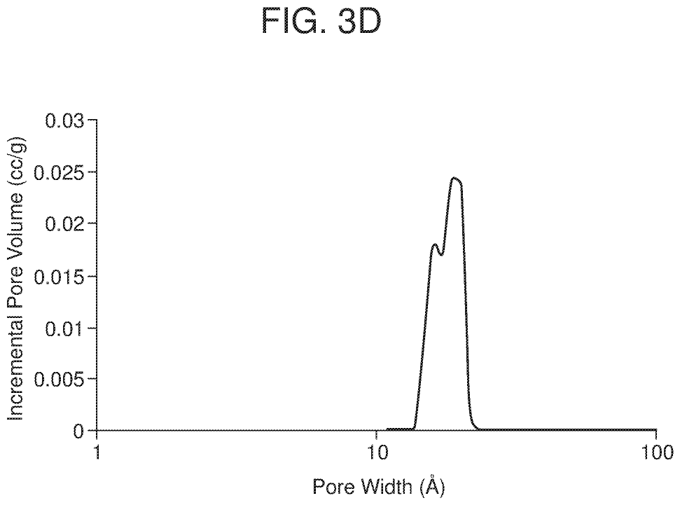

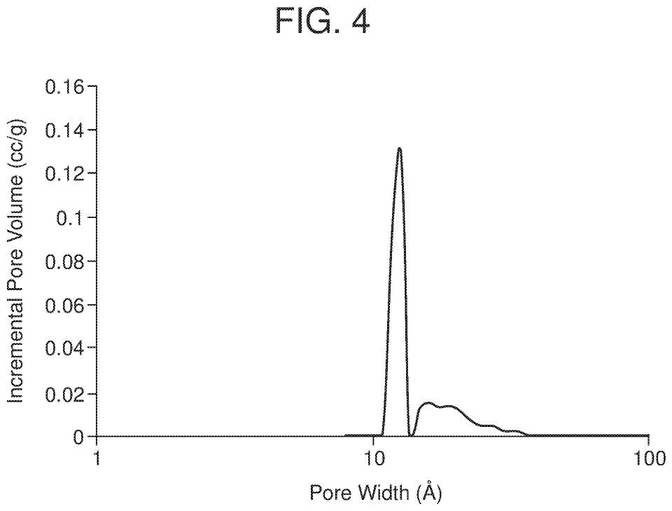

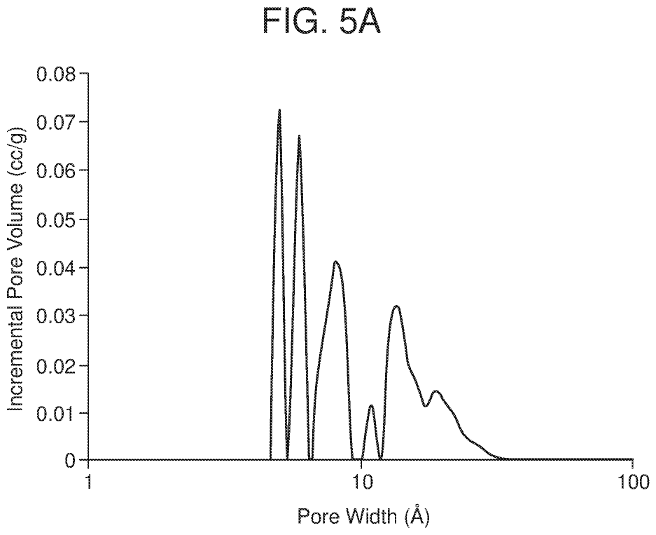

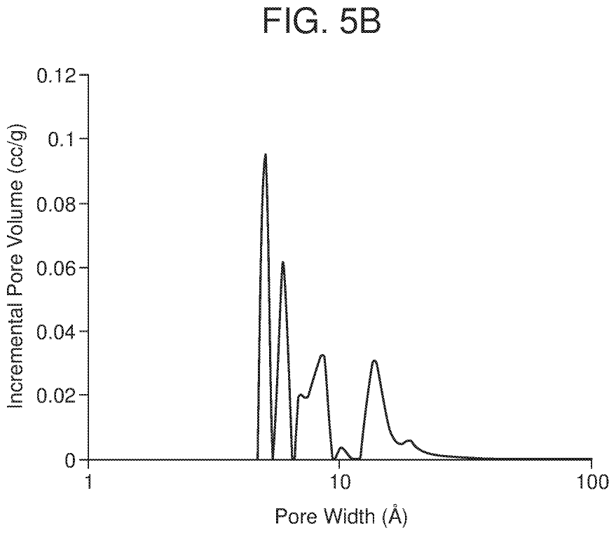

The data show that activation with steam creates activated carbons with greater microporosity than with CO₂, as expected. Typically, CO₂ activation develops more mesoporosity in activated carbons. Surface areas ranged from 730 to over 1100 m²/g with total pore volume at around 0.45 cc/g for most samples. The nitrogen BET pore size distributions for the spent beer grain samples are shown in FIGS. 3a-d. Nitrogen BET pore size distribution for the bourbon stillage sample is shown in FIG. 4. In general the activated carbon samples are highly microporous. IUPAC classification of pore diameters is as follows: micropores, <2 nm, mesoporous between 2 and 50 nm and macropores>50 nm.

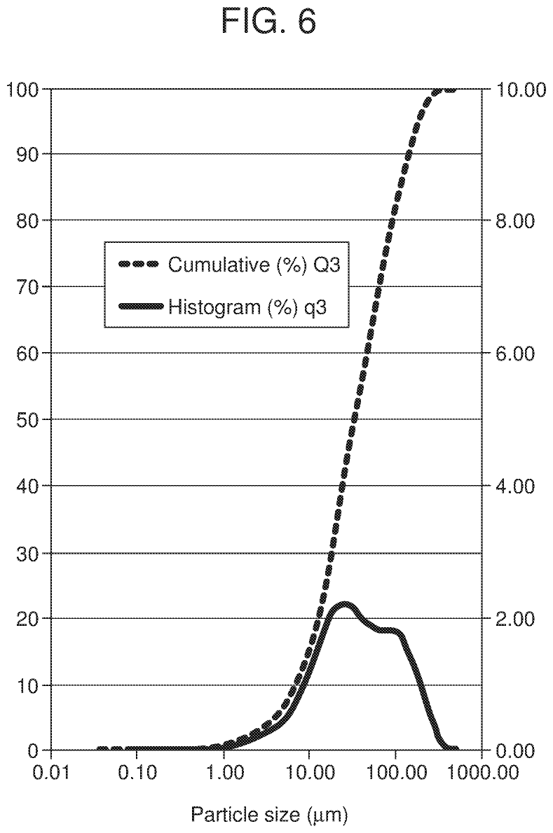

Two samples of activated carbon were received from GE (GS 06 and GS 07) and evaluated for nitrogen adsorption surface area, pore volume and pore distribution. The pore size distributions for these two samples are given in FIGS. 6a and b. The BET data show that sample GS06 had a slightly larger surface area than sample GS07. Sample GS06 also had a slightly higher pore volume and higher mesoporosity than sample GS07. The BET surface area, total pore volume and pore size distribution for the few activated carbon samples prepared from beer and bourbon waste fall within the values obtained from the two activated carbon samples obtained from GE. The major differences are observed in the incremental pore size distributions which for the GE samples do not show a uniform (even) distribution like the monomodal distribution functions shown for the activated carbons obtained from waste precursors. In essence, GE06 and 07 show several maxima appearing within mesoporosity range.

TABLE 2
Nitrogen BET isotherm results for
activated carbons obtained from GE.

| | BET | TVP | | | |
|---|---|---|---|---|---|
| Material ID | (m2/g) | (cc/g) | Micro | Meso | Macro |
| GS 06 | 1171 | 0.4356 | 92.7 | 6.9 | 0.4 |
| GS 07 | 962 | 0.3532 | 97.4 | 2.3 | 0.3 |

Particle size analysis. Particle size analysis was performed on Carb 783 obtained from bourbon stillage after the hydrothermal process (green carbon) in order to determine the particle size distribution of the material and determine what changes in the growth parameters are needed to obtain the desired particle size distribution. A histogram of the sample is presented in FIG. 6 and shows the particle size distribution. The mean particle size (d50) was 32.5 μm. The d10 and d90 for this sample were 7.26 μm and 138.8 μm, respectively. The growth conditions for the sample need to be modified in order to obtain particle sizes in the 50 to 100 μm range which are typical of the current activated carbons used in water filtration.

Second Data Set

A number of activated carbon samples were obtained. The carbon samples included loose granular powder, polymer-bonded blocks to actual filter cartridge products. The various samples are listed in Table 3.

TABLE 3
List of samples.

| Sample ID | Description | Sample preparation |
|---|---|---|
| GS04 | GE developmental | Powder filed from block |
| | chloramine reduction block | |
| GS05 | GE developmental VOC | Powder filed from block |
| | reduction block | |
| GS06 | Coconut granular activated | As-received and ground |
| | carbon | powder |
| GS07 | Coconut granular activated | As-received and ground |
| | carbon for chloramine | powder |
| | reduction | |
| GS08 | MWF block | Powder filed from block |
| GS09 | RPWF block | Powder filed from block |

Surface area characterization for activated carbon samples. For the polymer-bonded carbon blocks, powder was obtained by filing the block with a metal file and collecting the powder for nitrogen adsorption/desorption analysis. In the case of the coconut shell granular samples, nitrogen adsorption/desorption analysis was carried out on both the as-received granular form and powder form (by hand grinding).

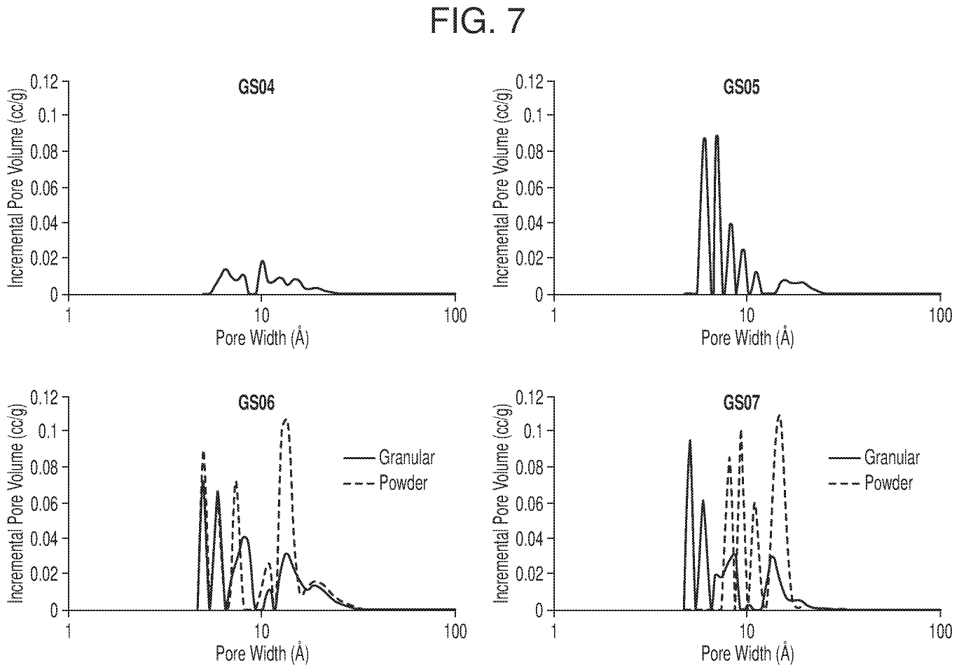

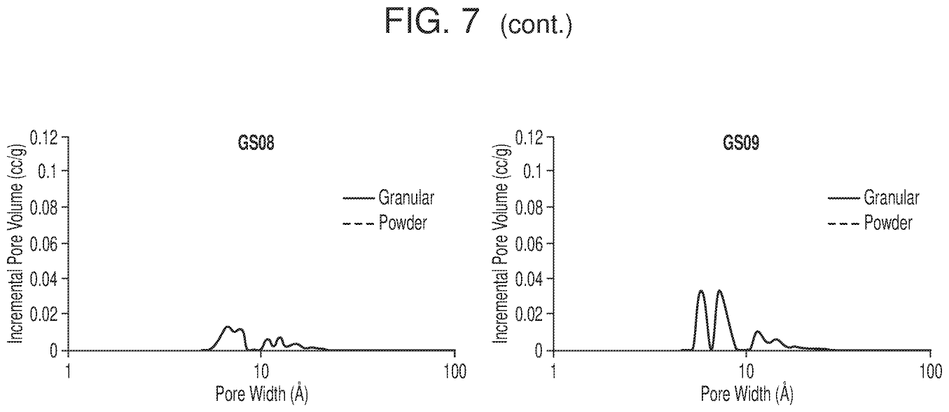

Table 4 and FIG. 7 summarize the BET surface area, pore volume, and pore distribution of all carbon samples received from GE. In general, activated carbons obtained from the polymer-bonded blocks showed much lower porosity comparing with the raw coconut carbon possibly resulting from polymer binder that may block the pore volume of the activated carbon particles. In addition, after grinding, samples GS06 and GS07 showed higher BET surface area and pore volume due to the smaller particle size. This is also shown in the pore volume distributions shown in FIG. 7.

TABLE 4
Nitrogen BET surface area, pore volume, and pore distribution.

| | BET | TVP | | | |
|---|---|---|---|---|---|
| Sample | (m²/g) | (cc/g) | Micro | Meso | Macro |
| GS04 | 361 | 0.136 | 90.7 | 8.9 | 0.4 |
| GS05 | 710 | 0.2727 | 96 | 3.70 | 0.3 |
| GS06 | 1171 | 0.4356 | 92.7 | 6.9 | 0.4 |
| granular | | | | | |
| GS06 | 1250 | 0.4777 | 89.3 | 9.8 | 0.9 |
| powder | | | | | |
| GS07 | 962 | 0.3532 | 97.4 | 2.3 | 0.3 |
| granular | | | | | |
| GS07 | 1121 | 0.4207 | 96.8 | 2.7 | 0.5 |
| powder | | | | | |
| GS08 | 242 | 0.09296 | 91.6 | 7.6 | 0.8 |
| GS09 | 467 | 0.177 | 90.3 | 9.6 | 0.1 |

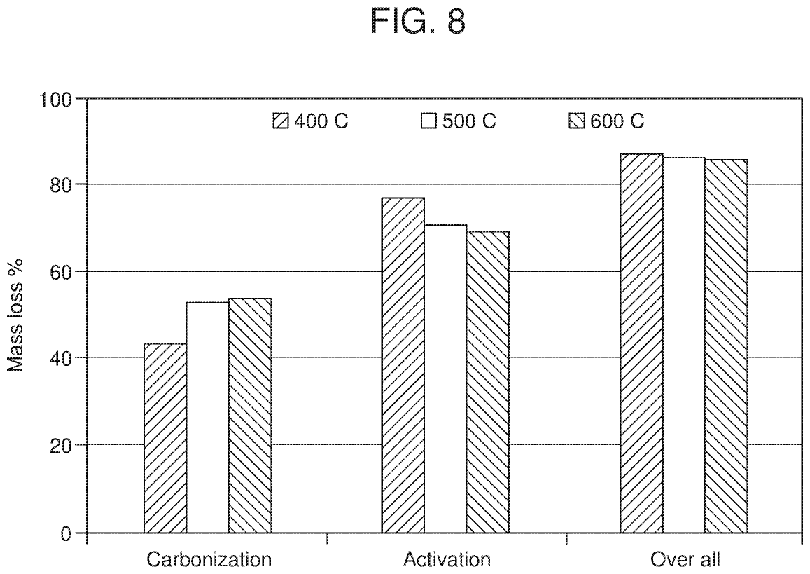

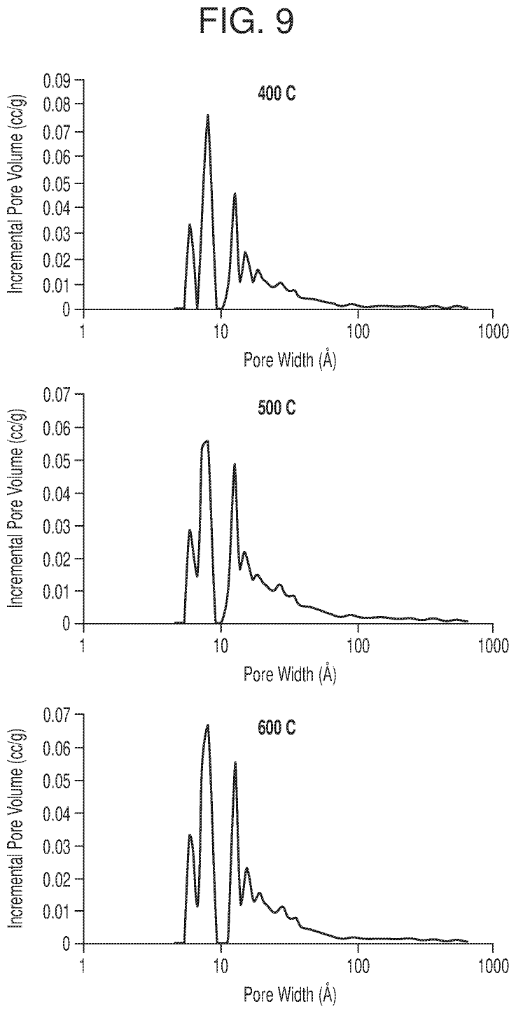

Carbonization and steam activation of bourbon stillage derived carbon. Work continued on the hydrothermal carbonization of activated carbons from bourbon stillage. One gallon of bourbon stillage was sealed in a 2 gallon glass lined hydrothermal pressure vessel and treated at 200° C. for 5 hours. The pressure vessel was allowed to cool down naturally and solid product was collected by filtration and dried at 100° C. overnight. Approximately 200 g of solid brown product was harvested for the batch. The as-synthesized carbon was soaked in isopropanol for 4 hours to dissolve organic residuals. Approximately 25% of the mass of the sample was lost after soaking likely due to organic residuals which were extracted by the isopropanol. The sample was then carbonized in nitrogen at three different temperatures (400, 500 and 600° C.). The three carbonized samples were then activated under the same conditions (steam at 850° C.). FIG. 8 shows the comparison of the mass loss for the 3 samples after carbonization at the various temperatures. Lower carbonization temperature resulted in a lower mass loss but resulted in higher mass loss during activation as expected. Interestingly, the overall mass loss for the 3 different activation routes were very similar. Nitrogen adsorption/desorption analysis were obtained on the three samples to evaluate surface area and pore distribution. Table 5 and FIG. 9 show a summary of these results. Surface area and pore volume for the bourbon stillage derived activated carbons were similar to the granular coconut carbons received from GE. There was no significant difference in the surface area and pore distribution for the 3 samples. From an energy saving prospective the lower carbonization route (400° C.) would offer a better choice due to the lower energy consumption required.

TABLE 5
BET surface area, pore volume, and pore distribution
for activated carbon prepared from bourbon stillage.

| Sample | | | | | |
|---|---|---|---|---|---|
| Carbonization | BET | TVP | | | |
| Temp (C.) | (m2/g) | (cc/g) | Micro | Meso | Macro |
| 400 | 1153 | 0.5275 | 71.1 | 26.2 | 2.7 |
| 500 | 1184 | 0.5517 | 67.7 | 29.9 | 2.4 |
| 600 | 1198 | 0.5302 | 73.0 | 25.1 | 1.9 |

Third Data Set

Work continued on characterizing the activated carbon samples. In addition, activated carbons prepared from the hydrothermal carbonization of bourbon stillage and their characterization continued in parallel. Selected samples which have been characterized and reported herein are shown in Table 6. For comparison, an activated carbon sample prepared from the hydrothermal carbonization of bourbon stillage is also shown. Carb 801 was prepared by hydrothermally treating the stillage at 200° C. for 5 hours, followed by steam activation at 850° C. for 30 min.

TABLE 6
List of samples obtained for Third Data set

| Sample ID | Description | Sample preparation |
|---|---|---|
| GS03 | Chloramine reduction filter - | Powder filed from block |
| | low pressure drop | |
| GS04 | GE developmental | Powder filed from block |
| | chloramine reduction block | |
| GS05 | GE developmental VOC | Powder filed from block |
| | reduction block | |
| GS06 | Coconut granular activated | As-received and ground |
| | carbon | powder |
| GS07 | Coconut granular activated | As-received and ground |
| | carbon for chloramine | powder |
| | reduction | |
| GS08 | MWF block | Powder filed from block |
| GS09 | RPWF block | Powder filed from block |
| Carb 801 | U of Kentucky developed | As-prepared powder |
| | activatpd carbon | |

Surface area characterization for activated carbon samples. For the polymer-bonded carbon blocks, powder was obtained by filing the block with a metal file and collecting the powder for nitrogen adsorption/desorption analysis. In the case of the coconut shell granular samples, nitrogen adsorption/desorption analysis was carried out on both the as-received granular form and powder form (by hand grinding).

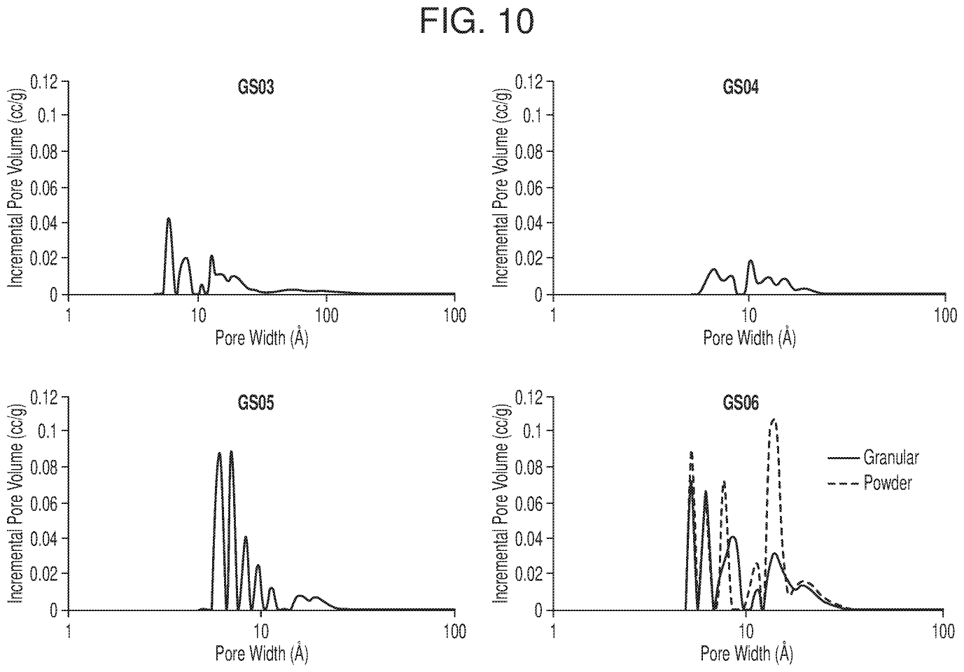

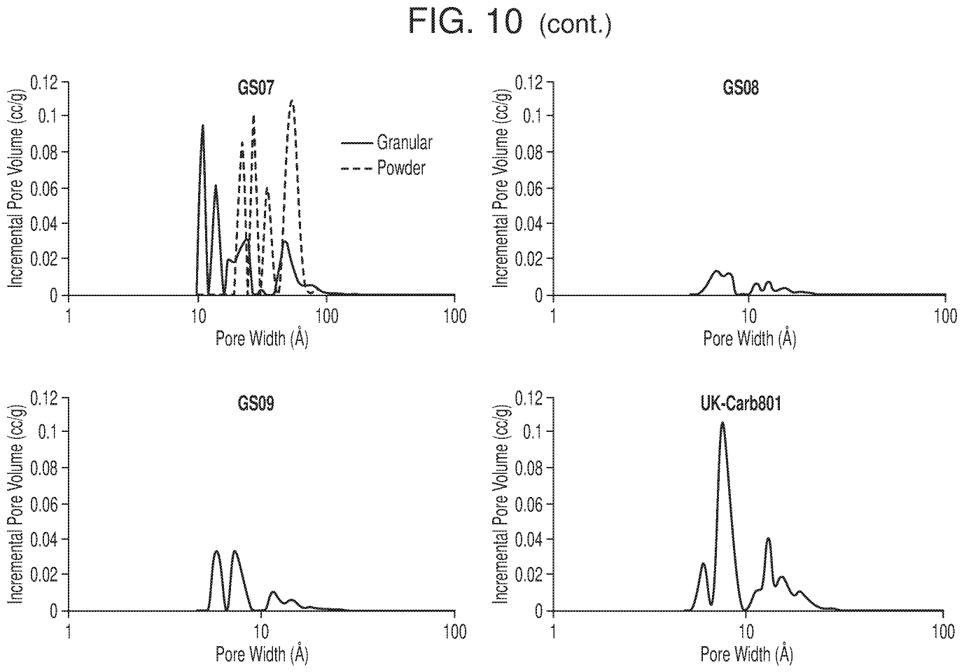

Table 7 summarizes the BET surface area, pore volume, and pore distribution of all activated carbon samples listed in Table 6. As reported previously, activated carbons obtained from the polymer-bonded blocks showed much lower porosity comparing with the raw coconut carbon possibly resulting from polymer binder. The assumption was made that polymer binder likely blocks the pore volume/surface area of the activated carbon particles. Also shown, after grinding, samples GS06 and GS07 showed higher BET surface area and pore volume most likely due to the smaller particle size. This was also shown in the pore volume distributions for these samples, before and after grinding. Nitrogen incremental BET pore volume distribution for all samples are shown in FIG. 10. The data reveal the effect of post grinding on the pore distribution of the activated carbons and the highly microporous nature of the materials used in this application. Steam activated carbons prepared from the hydrothermal carbonization of stillage consistently show high BET surface areas and well defined microporosity as expected.

TABLE 7
Nitrogen BET surface area, pore volume, and pore distribution

| | BET | TVP | | | |
|---|---|---|---|---|---|
| Sample ID | (m2/g) | (cc/g) | Micro | Meso | Macro |
| GS03 | 577 | 0.2595 | 73.3 | 26.6 | 0.1 |
| GS04 | 361 | 0.136 | 90.7 | 8.0 | 0.4 |
| GS05 | 710 | 0.2727 | 96.0 | 3.7 | 0.3 |
| GS06 | 1171 | 0.4356 | 92.7 | 6.9 | 0.4 |
| granular | | | | | |
| GS06 | 1250 | 0.4777 | 89.3 | 9.8 | 0.9 |
| powder | | | | | |
| GS07 | 962 | 0.3532 | 97.4 | 2.3 | 0.3 |
| granular | | | | | |
| GS07 | 1121 | 0.4207 | 96.8 | 2.7 | 0.5 |
| powder | | | | | |
| GS08 | 242 | 0.09296 | 91.6 | 7.6 | 0.8 |
| GS09 | 467 | 0.177 | 90.3 | 9.6 | 0.1 |
| Carb 801 | 1211 | 0.4533 | 94.1 | 4.8 | 1.1 |

Preliminary chloroform adsorption analysis using the Alpha MOS E-nose system. The E-nose instrument was delivered and set up at the CAER labs. Some preliminary data was collected using chloroform contaminated DI water to demonstrate the capabilities of the instrument.

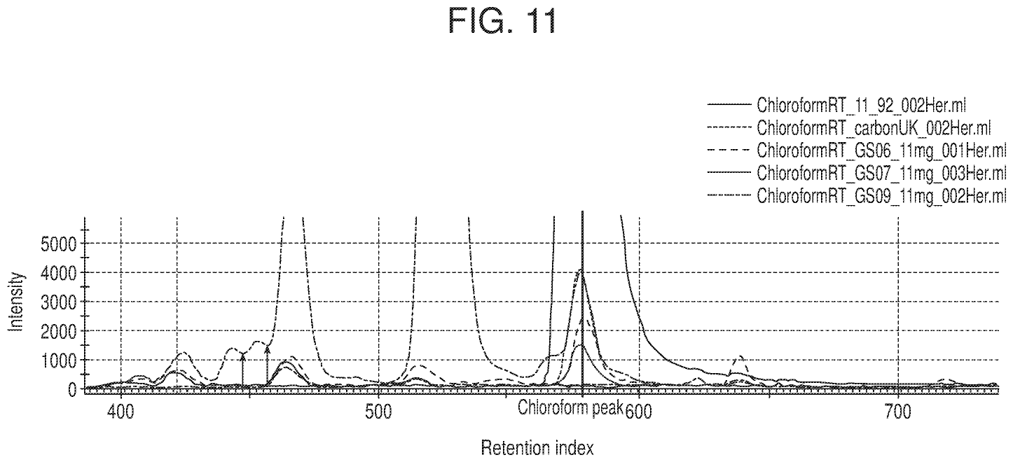

In one experiment, a 10 mL sample of DI water was spiked with chloroform at a concentration of 11.92 mg/L. Several samples of activated carbon (50 mg each) were put into vials containing 10 mL of the chloroform spiked water. The samples included GS 06, 07, 08 and Carb 801. GC spectra were taken after the samples were agitated at room temperature. A background GC MS scan was performed on the neat chloroform spikes sample without the addition of activated carbon for comparison. The chloroform spiked water was exposed to activated carbon for less than 1 hour. The data collected for these tests are shown in FIG. 11. The data shown clearly that the addition of activated carbon greatly reduced the chloroform signal (@ ^{˜}580) for all carbons. It should be noted that this is a highly preliminary result and any detailed quantitative analyses for the efficacy and performance of the various carbons for VOC adsorption can only be determined with a well-controlled and established experimental protocol.

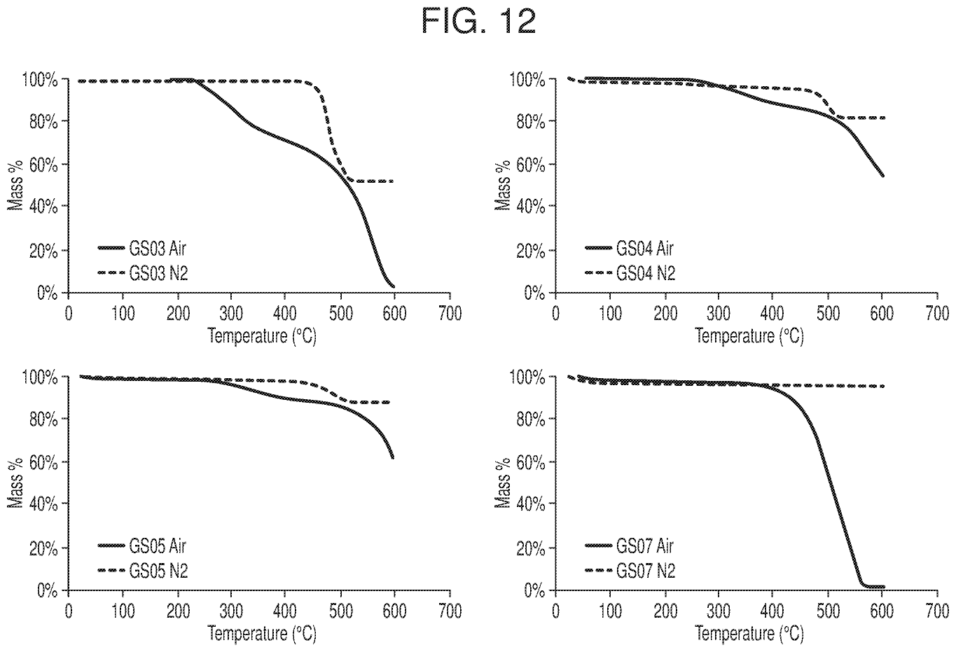

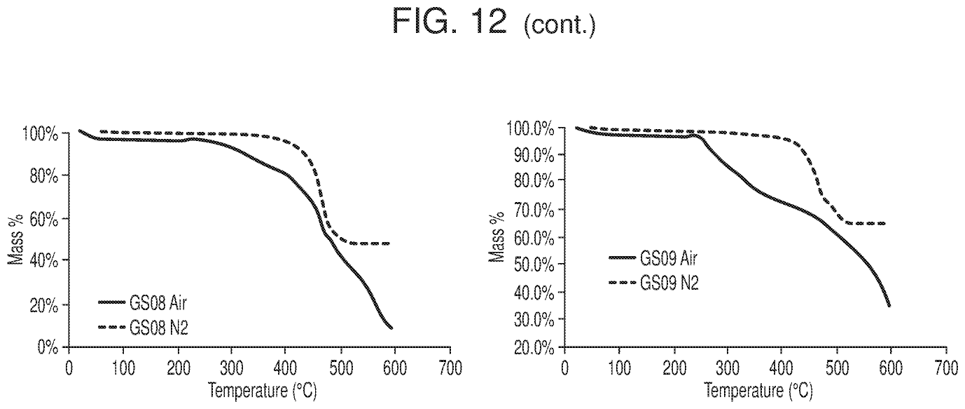

Thermogravimetric analysis (TGA) of activated carbon block samples. Thermogravimetric analysis was conducted on all of the activated carbon filter blocks received from GE. TGA is an analytical technique used to determine a material's thermal stability and the fraction of volatile components by monitoring the weight change that occurs as a sample is heated. Typically, the measurement is carried out in air or in an inert atmosphere (He or Ar) and the sample weight is recorded as a function of increasing temperature. The idea was that as the polymer-bonded activated carbon block was heated, the polymer would be volatized and burned off as the temperature was increased and the recorded sample mass loss would be an approximate measure of the amount of binder used in forming the block. The results of the TGA experiments are shown in FIG. 11. TGA experiments were performed in both air and nitrogen (FIG. 12). As a control to determine the stability of the activated carbon, sample GS 07, a binder-free carbon was also subjected to TGA analysis in both air and nitrogen environments. The data show that the activated carbon begins to volatize at around 400° C. and is completely volatized at about 550° C. in air. In nitrogen, the activated carbon is very stable and shows little mass loss over the same temperature range. The mass loss recorded for the polymer-bonded activated carbon filters in nitrogen was used to estimate the amount of binder present in the filter blocks. These results are summarized in Table 8.

TABLE 8
TGA results.

| | Mass loss % | Estimated | Block | Estimated AC |
|---|---|---|---|---|
| | in N₂ | AC | BET sur- | BET sur- |
| | (estimated | content | face area | face area |
| Sample ID | binder content) | (%) | (m²/g) | (m²/g) |
| GS03 | 48.2% | 51.8% | 577 | 1114 |
| GS04 | 18.5% | 81.5% | 361 | 442 |
| GS05 | 12.7% | 87.3% | 710 | 813 |
| GS07 (binder | — | — | 1121 | — |
| free) | | | | |
| GS08 | 52.3% | 47.7% | 242 | 507 |
| GS09 | 35.4% | 64.6% | 467 | 723 |

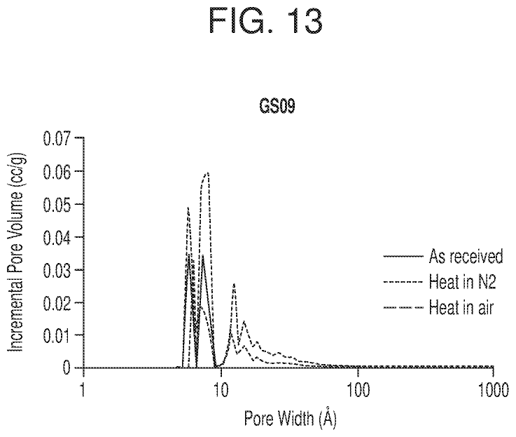

In addition to the TGA analysis to estimate binder content, sample GS 09 was subjected to two thermal treatments in a tube furnace using flowing air and nitrogen. In each case, the sample was heated at 400° C. for 1 hour. After the thermal treatments, nitrogen BET surface area and pore size distribution activated carbon were collected. These data are shown in FIG. 13 and summarized in Table 9. The data collected for this sample using TGA and the furnace experiment in air show good correlation in terms of the mass loss which may be attributed to the volatilization of the polymer binder.

TABLE 9
BET surface area, pore volume, and pore distribution for GS09

| | Mass Loss | BET | TVP | | | |
|---|---|---|---|---|---|---|
| Sample ID | (%) | (m2/g) | (cc/g) | Micro | Meso | Macro |
| GS09 | — | 467 | 0.177 | 90.3 | 9.6 | 0.1 |
| Heated in | 10 | 449 | 0.1767 | 89.0 | 10.9 | 0.1 |
| N2 at 400 C. | | | | | | |
| for 1 hr | | | | | | |
| Heated in | 35 | 753 | 0.311 | 85.2 | 14.7 | 0.1 |
| air at 400 C. | | | | | | |
| for 1 hr | | | | | | |

Fourth Data Set

During this period, work focused on four major areas; 1. Learning/training on the Alpha MOS HERACLES Flash Gas Chromatography Electronic Nose, 2. Generating calibration curves using chloroform and the Alpha MOS system, 3. Selection and adoption of an acceptable and reproducible VOC experimental testing protocol and 4. Conducting initial chloroform (trichloromethane) adsorption experiments using activated carbons.

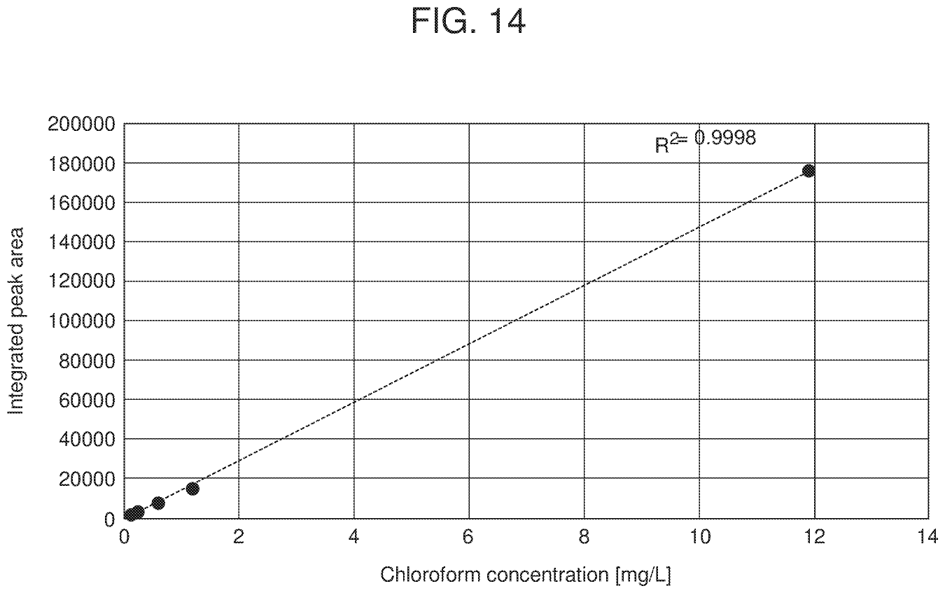

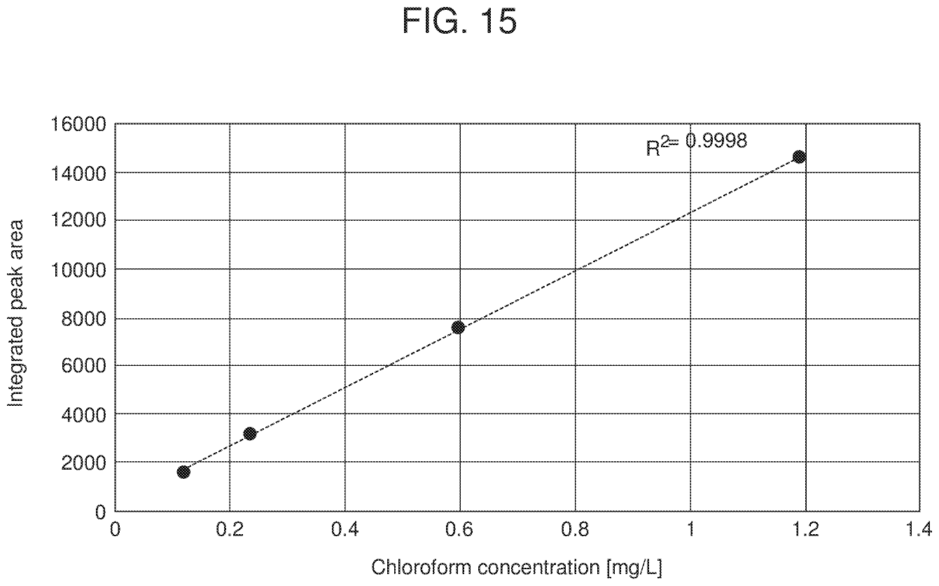

Chloroform standardization. Chloroform standardization curves were generated using the Alpha MOS system and test specimens using trichloromethane (Alfa Aesar, HPLC grade, 99.5%) and Millipore water (Merck, SupraSolv® used for headspace gas chromatography). Chloroform/organic-free water ranging in chloroform concentrations from 400-500 μg/L down to 10 μg/L were generated. In a typical experiment, a set of serial sample dilutions of known chloroform concentration were prepared in triplicate and analyzed by GC/MS to determined repeatability. Chloroform concentrations were measured using GC/MS collected from the headspace of vials containing each chloroform VOC concentration. These data were used to generate standardization curves as well as to define the sensitivity threshold for the sample assay. The series of chloroform solutions of known concentrations were prepared and analyzed to determine if they fit a linear regression, which they did as evidenced by the high linear regression (R2 value). Typical data are shown in FIGS. 14 and 15 for various chloroform concentration ranges.

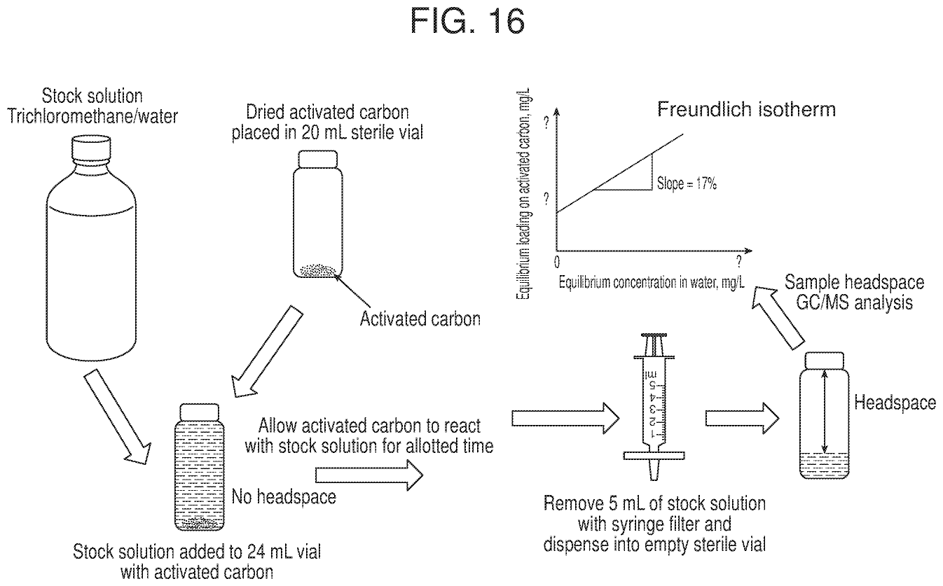

Adsorption capacity experiments. Three different experimental variant protocols were explored for performing chloroform adsorption using activated carbons. Based on initial testing, sample preparation and handling and data collection and reproducibility, the protocol shown schematically in FIG. 16 was adopted.

The objective for this data set was to develop and establish an acceptable and reliable experimental testing protocol to study the chloroform adsorption capacity of various activated carbons. A summary of the protocol shown in FIG. 16 is described as follow; trichloromethane (Alfa Aesar, HPLC grade, 99.5%) and Millipore water (Merck, SupraSolv® used for headspace gas chromatography) were used to prepare a controlled concentration of stock solution. A known mass of dried activated carbon was placed into an air-tight, sterile glass vial to which a known volume of chloroform spiked water was added. The activated carbon and spiked water were allowed to react for an allotted period of time, typically 5 and 24 hours. After the allotted reaction time, 5 mL of solution were withdrawn from the vial using a syringe filter and placed into a second sterile glass vial and sealed. The headspace form the vial was then collected by the Alpha MOS system and used to determine the concentration of chloroform.

AquaCarb 1230AWC. A variety of chloroform concentrations ranging from 0.031* (0.05*) to 64 (90) mg/L and activated carbon were used initially in this test as an adsorbent. The activated carbon used in our initial experiments was AquaCarb® 1230AWC (Westates® coconut shell based granular activated carbon from Siemens). The AquaCarb® is an activated carbon which is used specifically for potable water, wastewater and process water applications. It is acid washed yielding a very low ash content and pH neutral carbon.

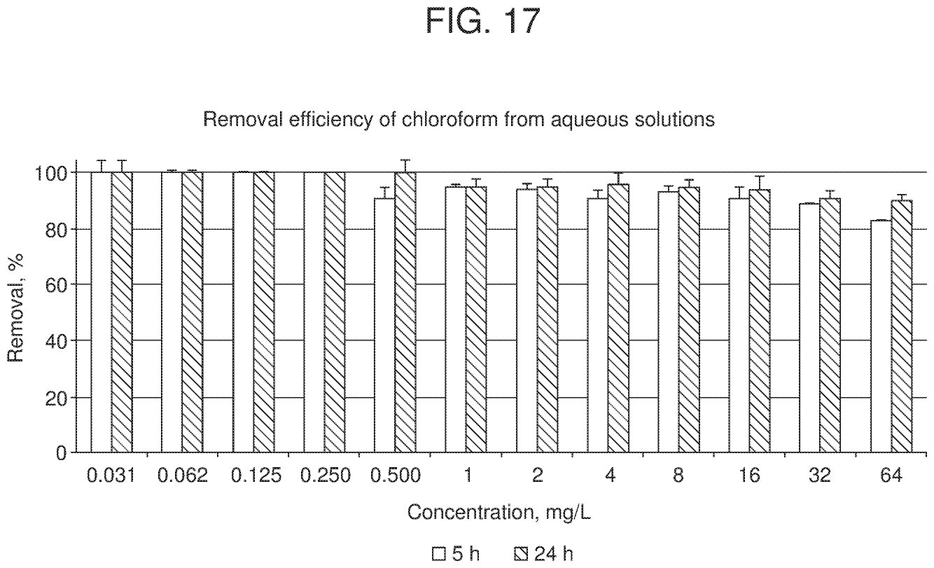

Prior to the chloroform adsorption experiment, the activated carbon was ground and sieved to collect samples with a median particle size of 50±10 μm. This material was subsequently dried overnight at 60° C. under vacuum. For each data collection, a 45 mg of activated carbon was used in a 24 ml air-tight, glass vial containing chloroform spiked water with the measured concentration. In a typical experiment, 4.91 μl of chloroform stock solution was added to 120 ml of Millipore water to a concentration 64 mg/L of chloroform spiked water. Other concentrations of chloroform spiked water down to 0.031 mg/L were obtained by serial dilutions. Typically, two samples of 5 ml spiked water for each concentration were immediately collected for analysis to determine the initial concentration of chloroform. Two 24 ml air-tight, glass vials containing activated carbon were used to assess the adsorption efficiency for each concentration. Two 5 ml samples of spiked water in contact with the activated carbon were collected from one vial after 5 hours of exposure and a second set of spiked water samples in contact with activated carbon samples were collected from another vial after 24 hours of exposure. In all cases, the activated carbon was left in contact with the spiked chloroform water at room temperature (20° C.) without any agitation. Results of the chloroform adsorption capacity experiments using AquaCarb® 1230AWC are shown in FIG. 17 as a function of chloroform concentration and exposure time.

Two similar chloroform adsorption capacity experiments were also performed using two activated carbon samples provided by General Electric, GS06 and GS07.

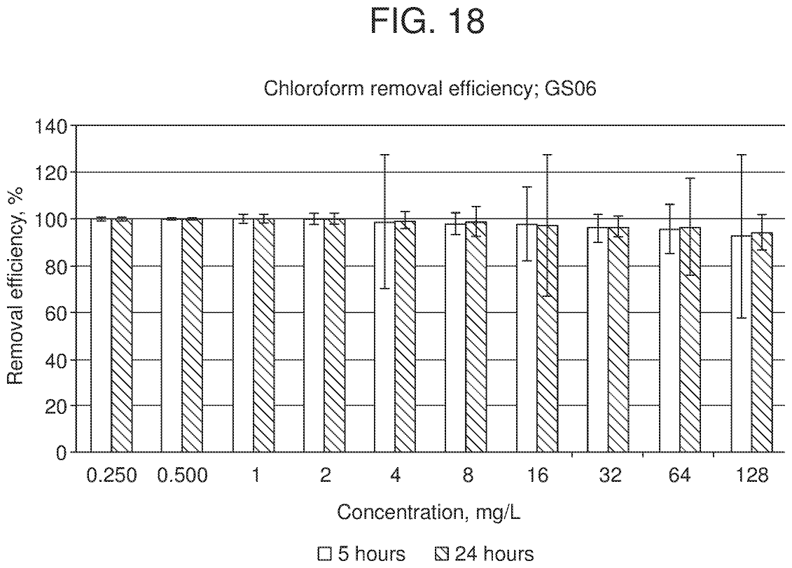

GS06. Spiked chloroform/Millipore water concentrations ranging from 0.250 (0.185*) to 128 (229) mg/L were prepare as described previously. GS06 from General Electric was used the activated carbon adsorbent. Prior to the experiment, the activated carbon was ground and sieved to collect particles with a mean size distribution of 50±10 μm. After grinding, the sample was dried overnight at 90° C. under vacuum. For each experimental data point, a 50 mg sample of dried activated carbon was placed in 24 ml air-tight glass vial containing the chloroform spiked water of known concentration. In a typical experiment, 18 μl of chloroform stock solution was added to 220 ml of Millipore water to obtain a concentration of 128 mg/L. Lower concentrations of solution were obtained by serial dilution. Typically, two samples of 5 ml spiked water for each concentration were immediately collected for analysis to determine the initial concentration of chloroform. Two 24 ml air-tight, glass vials containing activated carbon were used to assess the adsorption efficiency for each concentration. Two 5 ml samples of spiked water in contact with the activated carbon were collected from one vial after 5 hours of exposure and a second set of spiked water samples in contact with activated carbon samples were collected from another vial after 24 hours of exposure. In all cases, the activated carbon was left in contact with the spiked chloroform water at room temperature (20° C.) without any agitation. Results of the chloroform adsorption capacity experiments using GS06 are shown in FIG. 18 as a function of chloroform concentration and exposure time.

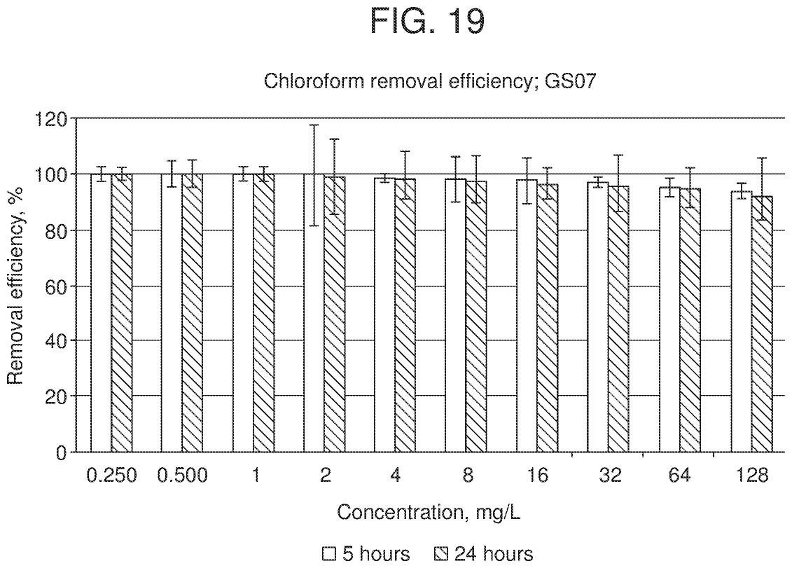

GS07. Spiked chloroform/Millipore water concentrations ranging from 0.250 (0.292*) to 128 (256) mg/L were prepare as described previously. GS07 from General Electric was used the activated carbon adsorbent. Prior to the experiment, the activated carbon was ground and sieved to collect particles with a mean size distribution of 50±10 μm. After grinding, the sample was dried overnight at 60° C. under vacuum. For each experimental data point, a 50 mg sample of dried activated carbon was placed in 24 ml air-tight glass vial containing the chloroform spiked water of known concentration. In a typical experiment, 18 μl of chloroform stock solution was added to 220 ml of Millipore water to obtain a concentration of 128 mg/L. Lower concentrations of solution were obtained by serial dilution. Typically, two samples of 5 ml spiked water for each concentration were immediately collected for analysis to determine the initial concentration of chloroform. Two 24 ml air-tight, glass vials containing activated carbon were used to assess the adsorption efficiency for each concentration. Two 5 ml samples of spiked water in contact with the activated carbon were collected from one vial after 5 hours of exposure and a second set of spiked water samples in contact with activated carbon samples were collected from another vial after 24 hours of exposure. In all cases, the activated carbon was left in contact with the spiked chloroform water at room temperature (20° C.) without any agitation. Results of the chloroform adsorption capacity experiments using GS07 are shown in FIG. 19 as a function of chloroform concentration and exposure time.

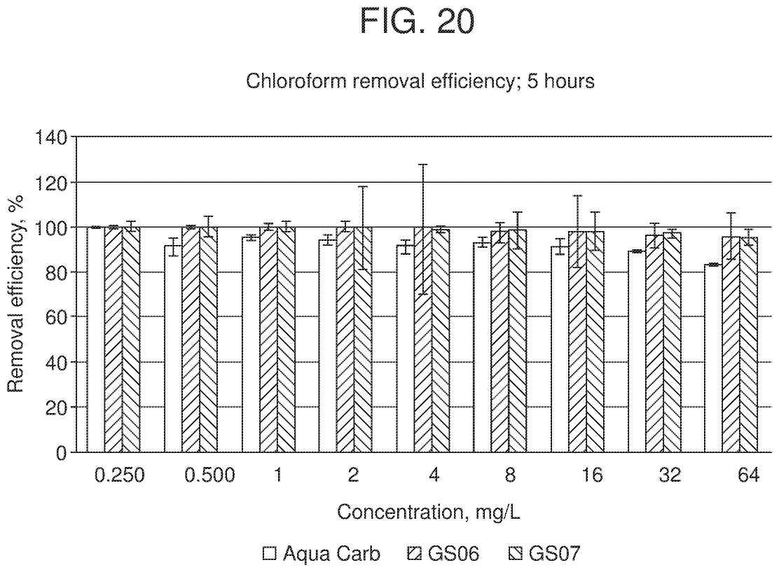

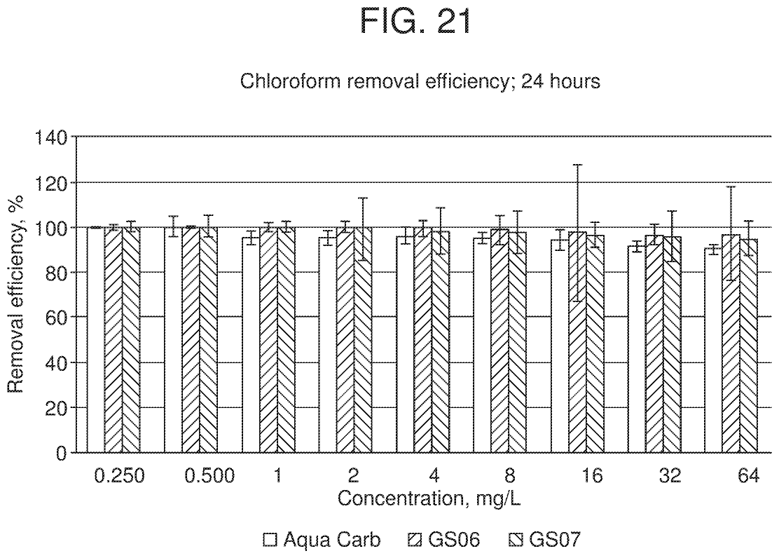

For comparison, chloroform adsorption capacity data for the three activated carbon (ACs) samples tested, AquaCarb® 1230AWC, GS06 and GS07, are plotted in FIGS. 20 and 21, at 5 and 24 exposure times, respectively.

Activated carbon/chloroform adsorption isotherms. Data collected using the protocol and methodology described previously for the activated carbon capacity experiments was used to generate adsorptions isotherms for chloroform on the three activated carbon samples, AquaCarb® 1230AWC, GS06 and GS07. Adsorption isotherms are used to characterize the ability of a particular activated carbon to remove a specific contaminant, such as a VOC. An important characteristic of interest for the activated carbon is the quantity of adsorbate (e.g., VOC) that it can adsorb. The adsorption isotherm relates the equilibrium relationship between adsorbate, adsorbent (activated carbon) and the equilibrium concentration of the adsorbate in water.

The two most common mathematical expressions used to relate adsorption isotherms are the Freundlich and Langmuir equations. The Freundlich isotherm is empirical and widely used to study heterogeneous systems where adsorption occurs at specific sites within the adsorbent. In this work, adsorption data was collected for the chloroform/water system using the aforementioned activated carbons and the Freundlich isotherm was used to analyze these data.

Chloroform/Millipore water samples were prepared over a range of concentrations, from 0.031 to 256 mg/L. Chloroform adsorption was conducted using 24 ml air-tight, glass vials containing either 45 mg of AquaCarb® 1230AWC or 50 mg of GS06, GS07 activated carbons. Prior to the experiment, the activated carbon was ground and sieved to collect particles with a mean size distribution of 50±10 μm (sieves 45 and 63 [symbol] m). After grinding, the samples were dried overnight at 60° C. under vacuum. For each experimental data point, a 50 mg sample of dried activated carbon was placed in 24 ml air-tight glass vial containing the chloroform spiked water of known concentration. Initial chloroform/water stock solution was prepared by dissolving chloroform in Millipore water to obtain the desired concentration. Lower concentrations of chloroform/water solutions were obtained by serial dilution. Typically, two 24 ml air-tight, glass vials containing activated carbon were used to assess the adsorption efficiency for each concentration.

The activated carbon samples were left in contact with the chloroform/water solution at room temperature (20° C.) without agitation for 5 or 24 hours. Once the desired exposure time was reached, sample solutions were collected and prepared as described previously for analysis by gas chromatography. Water/chloroform solutions were removed by syringe filtration and 5 ml of filtrate was placed into a 24 ml air-tight, glass vial which was sealed with a crimp cap and silicon septum. The sample was heated with agitation for 12 min at 40° C. to obtain equilibrium between the headspace and water/chloroform liquid fraction. Chloroform was detected by a flame ionization detector (FID) and identification was based on retention time of 18.8 and 21.7 s for the MXT-5-FID1 and MXT-1701-FID2 columns, respectively. Quantification of chloroform was based on the intensity of the FID signal using a 10 point calibration standard which was done automatically by the Alpha MOS software using linear regression.

The results of these VOC adsorption experiments were analyzed using the Freundlich adsorption isotherm equation. The Freundlich adsorption isotherm is commonly used for adsorption capacity calculations and has the following form;

qe=K_{F}Ce^{1/n}

where qe (mg/g) represents the amount of trichloromethane adsorbed (mg) per unit mass of activated carbon (AC), (g), Ce (mg/L) is the concentration of residual trichloromethane in the contaminated water solution after the AC and trichloromethane/water solution reach adsorptive equilibrium and K [(mg/g)(L/mg)1/n] is the Freudlich adsorption capacity parameter and 1/n (unitless) is the Freundlich adsorption intensity parameter. K is an indicator of the adsorption capacity; the higher the K value, the higher the maximum adsorption capacity (qe). The higher the 1/n value, the more favorable is the adsorption. In general, n<1 and 1/n>1. n and K are system specific constants.

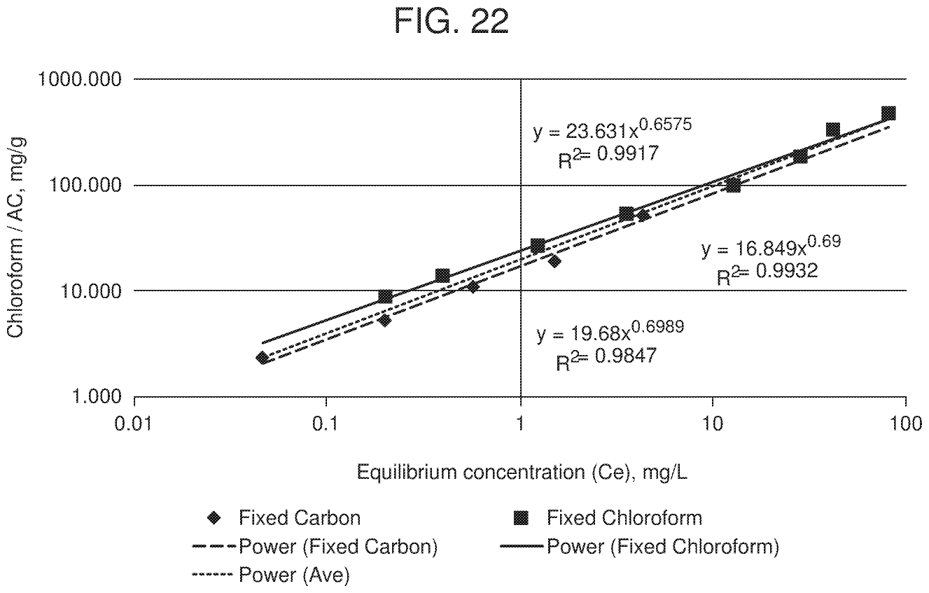

Data obtained for the three activated carbons are shown graphically in FIG. 22 as a log-log plot. In general, the data fit well to the Freundlich isotherm model (R2>0.97). Adsorption is favorable (1/n<1) and is considered a physical process where n>1. K values or the adsorption capacity obtained for GS06 and GS07 show that both activated carbon materials have comparable adsorptive capacities, whereas the adsorptive capacity of AquaCarb® 1230AWC is lower by more than a factor of 2. Freundlich adsorption constants and correlation coefficients (R2) are presented in Table 11 for the three activated carbons tested. Nitrogen BET surface area and pore distribution for GS06, GS07 and AquaCarb® 1230AWC are given in Table 12

The objective of the following experiment was to demonstrate and validate a modified and simplified experimental approach/methodology to evaluate the adsorption capacity of various activated carbons supplied by GE and prepared in our lab using waste bourbon stillage. In this experiment, activated carbon GS06, which is derived from coconut shell and obtained from GE was used as an example.

Sample preparation and analysis was the same as reported above with the following difference. In the previously reported adsorption experiments, the activated carbon mass used for each adsorption test was fixed or held constant and different concentrations of chloroform obtained by serial dilutions were used for each activated carbon/chloroform concentration. In the experiment reported herein, a fixed concentration of chloroform/water solution was used and exposed to different amounts of activated carbon.

The target concentration of chloroform in this experiment was 100 mg/L and the activated carbon masses used ranged from 5-500 mg per 24 ml vial of chloroform/water solution, which effectively resulted in chloroform/activated carbon ratios ranging from 20 to 0.2. These ratios were similar to those used in the fixed activated carbon experiments reported recently using the serial chloroform/water dilution method. Ratios at which the residual chloroform concentration at equilibrium was below the detection level of the analyzer were omitted.

The results from this experiment using a fixed chloroform concentration were analyzed using the Freundlich adsorption isotherm. A comparison of the adsorption results obtained from the fixed activated carbon experiment reported previously with those of the current experiment using fixed chloroform are presented in FIG. 22. Comparison the Freundlich adsorption isotherm parameters obtained for GS06 using the two experimental methods are shown in Table 10.

Similar 1/n values were obtained in both experimental methods, 0.6507 vs 0.69, indicating comparable adsorption affinity towards chloroform. K values (adsorption capacity coefficient) were different for the two experimental methods.

Overall the results obtained by both methods are reasonably comparable (similar 1/n or n values). Since using a fixed chloroform concentration allows for better control of experimental conditions and reduces experimental error giving more consistent results we feel strongly that this approach should be adopted and used in all future adsorption tests. One additional variable which remains to be tested is “exposure time”, or the time the spiked chloroform/water solution is in contact with the activated carbon. So far, all experiments were performed with an exposure time within 24 hours. Selection of the 24 hour exposure time was based on literature data and to some extent initial results obtained in our lab. We feel it would be prudent to demonstrate that 24 hour exposure time is sufficient to obtain equilibrium conditions. Future experiments using a longer exposure time are planned.

TABLE 10
Comparison of calculated Freundlich isotherm parameters
for adsorption of trichloromethane in water for
sample GS06 using two experimental methods.

| Method | 1/n | n | K | R2 |
|---|---|---|---|---|
| Fixed | 0.6507 | 1.54 | 23.63 | 0.9917 |
| chloroform | | | | |
| Fixed | 0.69 | 1.45 | 16.85 | 0.9932 |
| carbon | | | | |

TABLE 11
Calculated Freundlich Isotherm parameters for adsorption
of trichloromethane in water on activated carbon samples

| Activated carbon | 1/n | n | K | R² |
|---|---|---|---|---|
| AquaCarb | 0.8803 | 1.14 | 6.05 | 0.9777 |
| GS06 | 0.69 | 1.45 | 16.85 | 0.9932 |
| GS07 | 0.6787 | 1.47 | 15.43 | 0.9968 |

TABLE 12
Nitrogen BET surface area, pore volume, and pore distribution

| | BET | TVP | | | |
|---|---|---|---|---|---|
| Sample ID | (m2/g) | (cc/g) | Micro | Meso | Macro |
| GS06 | 1171 | 0.4356 | 92.7 | 6.9 | 0.4 |
| granular | | | | | |
| GS06 | 1250 | 0.4777 | 89.3 | 9.8 | 0.9 |
| powder | | | | | |
| GS07 | 962 | 0.3532 | 97.4 | 2.3 | 0.3 |
| granular | | | | | |
| GS07 | 1121 | 0.4207 | 96.8 | 2.7 | 0.5 |
| powder | | | | | |
| AquaCarb | 1282 | 0.4570 | 97.0 | 2.0 | 1.0 |

Fifth Data Set

Work continued on synthesizing activated carbons from bourbon stillage waste for VOC adsorption testing. To date, over 20 different activated carbon samples have been prepared and tested for chloroform adsorption. In all cases, bourbon stillage was obtained from Wilderness Trail Distillery (Danville, Ky.) and used as the precursor to prepare activated carbon. The stillage contained both liquid and solid (spent grain). Conversion of the bourbon stillage to activated carbon involved three basic steps, hydrothermal carbonization, carbonization at elevated temperature and physical activation. Hydrothermal carbonization was used to convert the liquid phase into solid hydrochar material. Carbonization was performed to stabilize the hydrochar for physical activation at elevated temperatures. All activations were performed using steam only. It should be noted that the second processing step, i.e., carbonization, could possibly be eliminated in order to reduce processing costs further or integrated into the activation step as a controlled thermal route.

For the chloroform adsorption tests, a fixed concentration of chloroform/water solution was used and exposed to different amounts of activated carbon as reported previously. The target concentration of chloroform for VOC adsorption tests was 100 mg/L and activated carbon masses used ranged from 5-500 mg per 24 ml vial of chloroform/water solution, which effectively resulted in chloroform/activated carbon ratios ranging from 20 to 0.2. All adsorption experiments were performed using an exposure time within 24 hours. Selection of the 24 hour exposure time was based on literature data and to some extent initial results obtained in our lab. VOC adsorption results using the fixed chloroform concentration and range of activated carbon masses were analyzed using the Freundlich adsorption isotherm.

Activated carbon preparation and analyses. Bourbon stillage form Wilderness Trail Distillery (Danville, Ky.) was placed into a stainless steel hydrothermal reactor and heated at 200° C. for 5 hours. There was no attempt to separate the liquid and solid (spent grain) phases from the stillage used in the hydrothermal carbonization and the stillage was used as-received. After the hydrochar was produced it was filtered dried and carbonized at various temperatures ranging from 350 to 550° C. This was done to determine the effect of carbonization on surface area properties of the activated carbon and ultimately on chloroform adsorption.

A summary of selected activated carbons prepared from bourbon stillage under various activation conditions and their respective surface area properties are given in Table 13. In all cases, the hydrochar was prepared by treating the stillage at 200° C. for 5 hours. Samples Carb 810, 821 and 822 represent activated carbons which had less than desired adsorptive VOC properties, while samples Carb 815, 816 and 817 had the best VOC adsorption properties of the activated carbon prepared from bourbon stillage to date. With the exception of Carb 822, the activated carbons prepared from stillage had relatively low surface area (<850 m2/g) and had a high degree of microporosity. Table 14 shows comparative nitrogen BET data for activated carbons received from GE. Two of the sample (GS06 and GS14) had relatively high surface areas exceeding 1300 m2/g and a higher degree of mesoporosity when compared to GS07 and GS13.

TABLE 13
Nitrogen BET surface area, pore volume, and pore distribution
of selected activated carbons prepared from stillage

| | | Steam | | | | | |
|---|---|---|---|---|---|---|---|
| Sample | Carbonization | Activation | BET | TVP | | | |
| ID | (C.) | (C.) | (m2/g) | (cc/g) | Micro | Meso | Macro |
| Carb 810 | 350 | 900 | 659 | 0.30373 | 84 | 13 | 3 |
| Carb 815 | 500 | 850 | 520 | 0.2314 | 97 | 2 | 1 |
| Carb 816 | 500 | 900 | 807 | 0.32081 | 96 | 3 | 1 |
| Carb 817 | 550 | 850 | 602 | 0.2114 | 96 | 3 | 1 |
| Carb 821 | 550 | 850 | 846 | 0.30945 | 98 | 1 | 1 |
| Carb 822 | 550 | 900 | 1294 | 0.55229 | 77 | 21 | 2 |

TABLE 14
Nitrogen BET surface area, pore volume, and pore distribution
of activated carbon samples provided by GE

| | BET | TVP | | | |
|---|---|---|---|---|---|
| Sample ID | (m2/g) | (cc/g) | Micro | Meso | Macro |
| GS06 | 1412 | 0.59084 | 80 | 19 | 1 |
| GS07 | 958 | 0.3891 | 92 | 7 | 1 |
| GS13 | 614 | 0.23284 | 93 | 6 | 1 |
| GS14 | 1347 | 0.53733 | 87 | 12 | 1 |

Activated carbon/chloroform adsorption isotherms. Chloroform VOC adsorption experiments were conducted as described in the previous report. To reiterate, results of these VOC adsorption experiments were analyzed using the Freundlich adsorption isotherm equation. The Freundlich adsorption isotherm is commonly used for adsorption capacity calculations and has the following form;

qe=K_{F}Ce^{1/n}

where qe (mg/g) represents the amount of trichloromethane adsorbed (mg) per unit mass of activated carbon (AC), (g), Ce (mg/L) is the concentration of residual trichloromethane in the contaminated water solution after the AC and trichloromethane/water solution reach adsorptive equilibrium and K [(mg/g)(L/mg)1/n] is the Freudlich adsorption capacity parameter and 1/n (unitless) is the Freundlich adsorption intensity parameter. K is an indicator of the adsorption capacity; the higher the K value, the higher the maximum adsorption capacity (qe). The higher the 1/n value, the more favorable is the adsorption. In general, n<1 and 1/n>1. n and K are system specific constants. VOC adsorption data obtained on the activated carbons were plotted as a log-log plot. In general, good data fit well to the Freundlich isotherm model when the R2>0.9 and adsorption is favorable (1/n<1) and is considered a physical process where n>1.

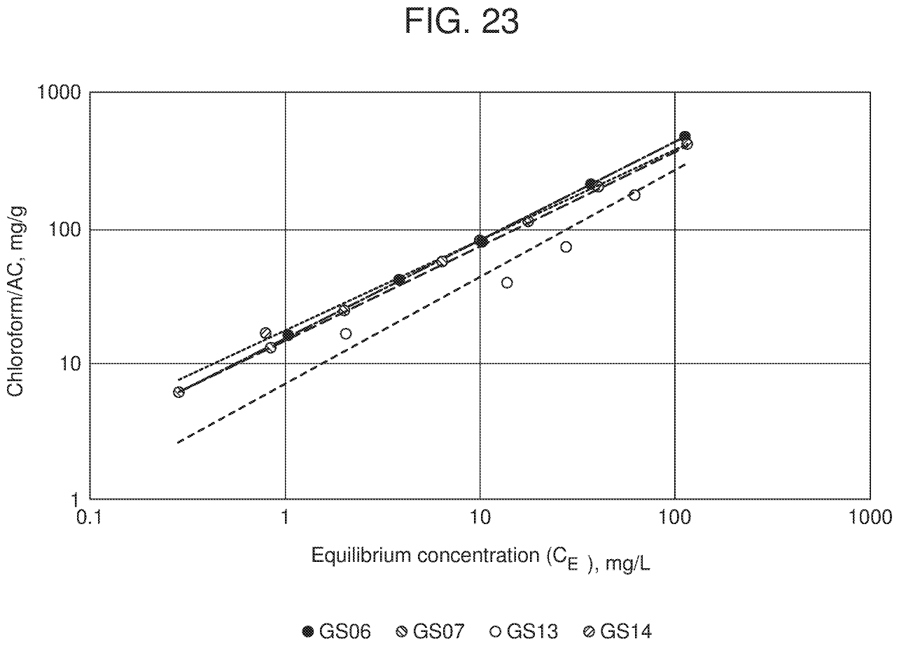

Freundlich isotherms for chloroform adsorption are shown in FIG. 23 for the four GS samples obtained from GE (Table 14). In general, three of the samples (GS07, 06 and 14) were comparable in terms of their adsorption capacities. GS13 showed the poorest chloroform adsorption performance of the group. Freundlich adsorption isotherm data are given in Table 13 for these materials which shows that sample GS14 had the highest chloroform adsorption capacity at 17.29 (mg/g)(L/mg)1/n while GS13 was 7.0 [(mg/g)(L/mg)1/n, at less the half the adsorption capacity of GS14. In general, samples GS06 and 07 were comparable to GS14, all displaying high chloroform adsorption efficiency.

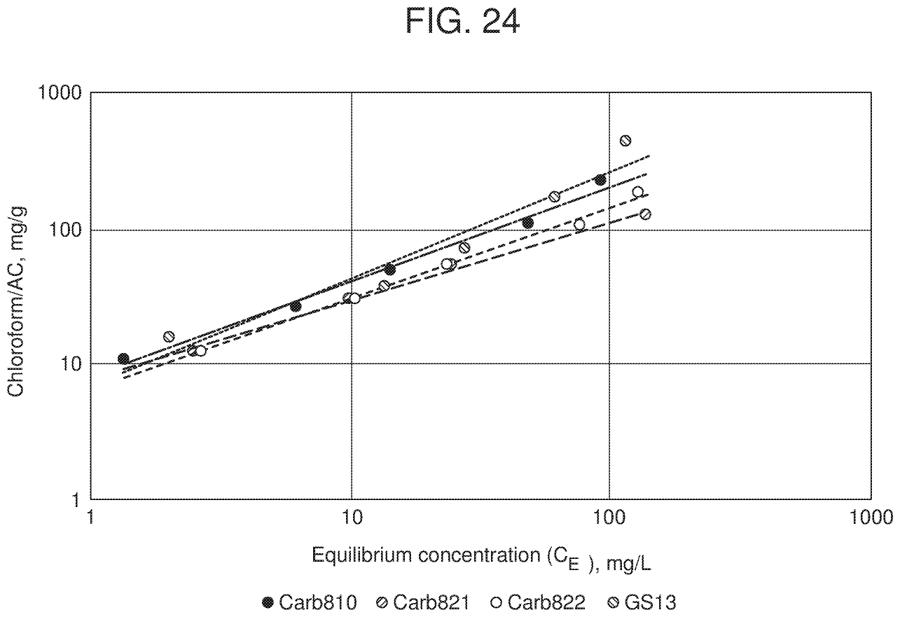

Freundlich isotherms for chloroform adsorption for samples Carb810, 821 and 822 are plotted in FIG. 24. For comparison, sample GS13 is also plotted. In general, these materials prepared from stillage were among the poorest activated carbons in terms of chloroform adsorption. Even so, they still display adsorption capacities (K values) either comparable to or exceeding that of GS13 as shown in Table 16. Note that the K values for Carb810 and 821 are high than that of sample GS13. 11010010001101001000CHLOROFORM

TABLE 15
Calculated Freundlich Isotherm parameters for adsorption
of trichloromethane in water on activated carbon samples

| | | | K | |
|---|---|---|---|---|
| Sample ID | 1/n | n | (mg/g)(L/mg)1/n | R2 |
| GS06 | 0.7225 | 1.38 | 15.5 | 0.9991 |
| GS07 | 0.7083 | 1.41 | 14.97 | 0.9996 |
| GS13 | 0.7942 | 1.26 | 7.052 | 0.9293 |
| GS14 | 0.6697 | 1.49 | 17.29 | 0.9965 |

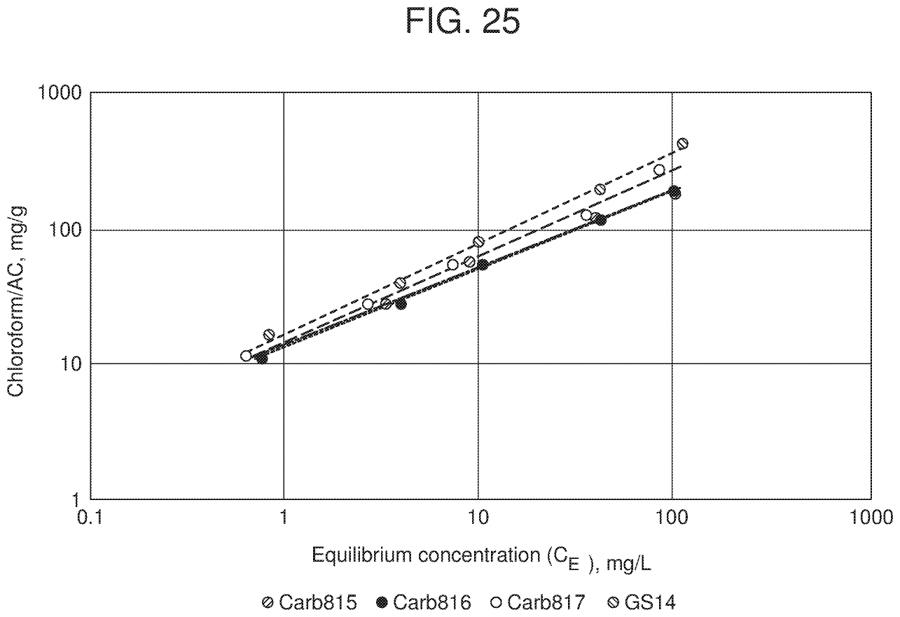

Freundlich isotherms for chloroform adsorption for samples Carb, 815, 816 and 817 are plotted in FIG. 25 and are compared to GS14, the best performing activated carbon to date. Freundlich isotherm data are also reported in Table 16 for these materials. The best performing activated carbon prepared from bourbon stillage to date is sample Carb817 with a adsorption capacity (K) of 15.07 (mg/g)(L/mg)1/n. This value is slightly lower that the adsorption capacity obtained for GS14 [17.29 (mg/g)(L/mg)1/n]. 11010010000.11101001000CHLOROFORM/AC, MG/GEQUILIBRIUM CONCENTRATION (CE), MG/LCarb815Carb816Carb817GS14

TABLE 16
Calculated Freundlich Isotherm parameters for adsorption
of trichloromethane in water on activated carbon samples

| | | | K | |
|---|---|---|---|---|
| Sample ID | 1/n | n | (mg/g)(L/mg)1/n | R2 |
| Carb 810 | 0.7031 | 1.42 | 8.19 | 0.9882 |
| Carb 815 | 0.5746 | 1.74 | 14.09 | 0.9973 |
| Carb 816 | 0.5859 | 1.71 | 13.22 | 0.9994 |
| Carb 817 | 0.6374 | 1.57 | 15.07 | 0.9972 |
| Carb 821 | 0.5769 | 1.73 | 8.28 | 0.9905 |
| Carb 822 | 0.6689 | 1.49 | 6.73 | 0.9942 |

Sixth Data Set

A series of additional carbon materials were prepared using bourbon stillage, high fructose corn syrup, fructose, glucose and mixtures (using supplemental additive aromatic compounds) with the various carbohydrates. The materials were activated using the standard steam activation process used previously (unless noted otherwise) and analyzed for nitrogen BET surface area and pore distribution. Typically, as-prepared carbon materials were subjected directly to activation at 850 or 900° C. for 1 to 3 hours. In some cases, the as-prepared materials were first subjected to a lower temperature (ranging from 450 to 550° C. for several hours) carbonization under nitrogen before steam activation. In addition, selected activated carbons were analyzed for VOC adsorption using trichloromethane (or chloroform).

In all cases, bourbon stillage was obtained from Wilderness Trail Distillery (Danville, Ky.) and used as the precursor. The stillage contained both liquid and solid (spent grain). In some cases, the spent grain was separated from the liquid portion of the stillage and each was used as precursors to prepare activated carbon to determine if there was any significant difference in VOC performance. High fructose corn syrup (HFCS-55), obtained from Cargill (Dayton, Ohio) was also used as a precursor to prepare activated carbons. HFCS-55 is used primarily in carbonated soft drinks and contains 55% fructose, 41% glucose 4% other sugars/polysaccharides. Other products forms of high fructose corn syrup are also available, for example, HFCS-42 which is used mainly in processed foods like cereals and baked goods and contains 42% fructose, 53% glucose and 5 other sugars/polysaccharides. In addition to HFCS-55, several activated carbon samples were prepared using only 100% fructose and 100% glucose as the precursor. Modified precursor materials were also prepared by adding additional aromatic (organic) compounds to either bourbon stillage or HFCS-55 to effect changes in the adsorptive VOC properties of the activated carbon.

In general, conversion of bourbon stillage or other precursor materials to activated carbon involved three basic steps, hydrothermal carbonization, carbonization under nitrogen at elevated temperature and physical activation. Hydrothermal carbonization was used to convert the liquid phase into solid carbonaceous material. Carbonization was performed at elevated temperatures ranging from 350 to 600° C. in order to stabilize the hydrothermal material for physical activation. Typically, activations were performed using steam only. In some cases, the intermediate carbonization step was eliminated completely and materials were steam activated directly after the hydrothermal process in order to determine the effect on surface area, pore distribution and VOC adsorption. In several rare instances, activations were performed using CO2 at 850° C.

Several activated carbon materials in the form of block, granulated activated carbon (GAC) and powdered activated carbon (PAC) were also obtained from General Electric (GE) Appliances and tested for VOC adsorption performance. The activated carbons received from GE Appliances and evaluated are given in Table 17.

TABLE 17
Activated carbon materials provided.

| Sample ID | Type | Description |
|---|---|---|
| GS06 | GAC | Std. coconut shell GAC |
| GS07 | GAC | Std. coconut shell catalytic |
| | | GAC for chloramine |
| | | reduction |
| GS12 | Block | Chloramine - VOC |
| GS13 | GAC | Raw material for GS12 |
| GS14 | PAC | Catalytic carbon powder |
| | | (same as G15) |
| GS15 | GAC | Catalytic carbon granules |
| | | (same as GS14) |

As before, the chloroform (trichloromethane) adsorption tests used a fixed concentration of chloroform/water solution and were exposed to various controlled amounts of activated carbon. The target concentration of chloroform for VOC adsorption tests was 100 mg/L and the activated carbon masses used were 5, 20, 60, 120 and 300 mg per 24 ml vial of chloroform/water solution, which effectively resulted in chloroform/activated carbon ratios ranging from 20 to 0.2. All adsorption experiments were performed using an exposure time of 24 hours. Selection of the 24 hour exposure time was based on literature data and to some extent initial test results obtained in our lab. VOC adsorption results using the fixed chloroform concentration and range of activated carbon masses were analyzed and fitted to the Freundlich adsorption isotherm.

Activated carbon preparation and analyses. In general, all precursor materials were placed into a stainless steel hydrothermal reactor and heated at 200° C. for 5 hours to produce carbonaceous solids. After the solids were produced, they were filtered dried and carbonized under nitrogen at various temperatures ranging from 350 to 600° C. The various carbonization temperatures were used to determine the effect of heat treatment on surface area and pore distribution properties of activated carbons and ultimately on chloroform adsorption. As noted in some cases, solids collected after the hydrothermal process were not carbonized and taken directly to steam activation to determine the effect on VOC adsorption performance. Typically, materials were steam activated at 850-900° C. for 1 to 3 hours. As mentioned, several samples were activated at 850° C. using CO₂.

A summary of selected activated carbons prepared directly from bourbon stillage under various activation conditions and their respective surface area properties are presented in Table 18. As can be seen, there are a range of surface properties for the various materials and for the most part can be attributed to the precursor formulation, intermediate carbonization step and activation conditions used.

With the exception of samples Carb 831, 832, 835, 836 and 837 which were activated using CO2, all other samples were activated with steam. In general, activation with CO2 yields activated carbons with higher surface area (>1000 m2/g) and higher total pore volume (TPV), ca. 0.5 cc/g or greater, when compared to steam activation. Regardless of the activation, the materials were highly microporous. Samples Carb 851, 853 and 854 were all taken directly to steam activation without any intermediate carbonization step.

As a comparison, surface area and pore size distribution data for activated carbon materials provided by GE Appliances are given in Table 19. It can be assumed that all of these materials are likely derived from coconut shell. Again, these materials show high microporosity and have a range of surface areas, from ca. 500 to 1400 m2/g. As will be shown for these and other materials prepared in our lab, activated carbons with exceptionally high surface areas (>ca. 1000 m2/g) and large TPV values (>0.7 cc/g) are not required for the effective removal of VOCs from water. In general, the TPV values for these materials is less than 0.6 cc/g.

TABLE 18
Nitrogen BET surface area, pore volume, and pore distribution
for selected activated carbons prepared from bourbon stillage.

| | | BET | TVP | | |
|---|---|---|---|---|---|
| Sample ID | Precursor | (m2/g) | (cc/g) | Micro | Meso |
| Carb 807 | 930 | 0.34237 | 97 | 2 | 1.5 |
| Carb 809 | 720 | 0.25371 | 96 | 3 | 1.5 |
| Carb 810 | 659 | 0.30373 | 84 | 13 | 3 |
| Carb 811 | 1719 | 0.77495 | 66 | 33 | 1.5 |
| Carb 812 | 804 | 0.28918 | 95 | 4 | 1.5 |
| Carb 813 | 619 | 0.22223 | 98 | 1 | 1 |
| Carb 814 | 819 | 0.32994 | 94 | 5 | 1.5 |
| Carb 815 | 520 | 0.2314 | 97 | 2 | 1 |
| Carb 816 | 807 | 0.32081 | 96 | 3 | 1 |
| Carb 817 | 602 | 0.2114 | 96 | 3 | 1 |
| Carb 818 | 653 | 0.23513 | 95 | 3 | 2 |
| Carb 819 | 435 | 0.12907 | 100 | 0 | 0 |
| Carb 820 | 548 | 0.18554 | 97 | 0 | 3 |
| Carb 821 | 846 | 0.30945 | 98 | 1 | 1 |
| Carb 822 | 1294 | 0.55229 | 77 | 21 | 2 |
| Carb 823 | 444 | 0.161 | 100 | 0 | 0 |
| Carb 824 | 864 | 0.30917 | 99 | 0 | 1 |
| Carb 825 | 560 | 0.20825 | 100 | 0 | 0 |
| Carb 826 | 519 | 0.1924 | 100 | 0 | 0 |
| Carb 827 | 606 | 0.2243 | 99.6 | 0 | 0.4 |
| Carb 828 | 513 | 0.17526 | 99.6 | 0 | 0.4 |
| Carb 829 | 551 | 0.21115 | 99 | 0 | 1 |
| Carb 830 | 482 | 0.16636 | 100 | 0 | 0 |
| Carb 831 | 1965 | 0.76679 | 84 | 15 | 1 |
| Carb 832 | 2331 | 0.93226 | 73 | 26 | 1 |
| Carb 833 | 719 | 0.23068 | 100 | 0 | 0 |
| Carb 834 | 716 | 0.24377 | 100 | 0 | 0 |
| Carb 835 | 1962 | 0.68068 | 100 | 0 | 0 |
| Carb 836 | 1387 | 0.49149 | 99.5 | 1 | 0 |
| Carb 837 | 2095 | 0.99032 | 50 | 50 | 0 |
| Carb 845 | 533 | 0.18186 | 100 | 0 | 0 |
| Carb 846 | 465 | 0.17297 | 100 | 0 | 0 |
| Carb 848 | 548 | 0.20289 | 100 | 0 | 0 |
| Carb 849 | 695 | 0.22771 | 100 | 0 | 0 |
| Carb 851 | 538 | 0.20226 | 99.6 | 0 | 0.4 |
| Carb 853 | 626 | 0.20137 | 100 | 0 | 0 |
| Carb 854 | 636 | 0.23432 | 100 | 0 | 0 |

TABLE 19
Nitrogen BET surface area, pore volume, and pore distribution
of activated carbon samples provided.

| | | BET | TVP | | |
|---|---|---|---|---|---|
| Sample ID | Precursor | (m2/g) | (cc/g) | Micro | Meso |
| GS06 | 1412 | 0.59084 | 80 | 19 | 1 |
| GS07 | 958 | 0.3891 | 92 | 7 | 1 |
| GS12 | 508 | 0.19402 | 99 | 0 | 1 |
| GS13 | 614 | 0.23284 | 93 | 6 | 1 |
| GS14 | 1347 | 0.53733 | 87 | 12 | 1 |
| GS15 | 1021 | 0.39959 | 96 | 3 | 1 |

Table 20 lists N₂ BET surface area and pore distributions for a series of activated carbons prepared from several commercial carbohydrates, fructose (C6H12O6), glucose (C6H12O6) and high fructose corn syrup (HFCS-55). As noted previously, HFCS-55 is used in the carbonated beverage industry as the main ingredient for sweetener and is composed of 55 percent fructose, 42 percent glucose and 3 percent other sugars/polysaccharides. Although fructose and glucose are both monosaccharides and have the same chemical formula, they differ slightly in their chemical structure. In other words, fructose and glucose are isomers; compounds with the same formula but different arrangement of atoms in the molecule and different properties. The surface area data show that all of the activated carbons prepared from these carbohydrates were consistent, having similar characteristics, i.e., surface areas ranging from about 600 to 800 m2/g, total pore volume (ca. 0.25 cc/g) and are entirely microporous.

TABLE 20
Nitrogen BET surface area, pore volume, and pore distribution of
activated carbon samples prepared from commercial carbohydrates.

| | | BET | TVP | | | |
|---|---|---|---|---|---|---|
| Sample ID | Precursor | (m2/g) | (cc/g) | Micro | Meso | Macro |
| Carb 852 | HFC-55 | 629 | 0.20935 | 100 | 0 | 0 |
| Carb 857 | HFC-55 | 532 | 0.19498 | 100 | 0 | 0 |
| Carb 860 | HFC-55 | 689 | 0.24366 | 100 | 0 | 0 |
| Carb 864 | HFC-55 | 696 | 0.25626 | 100 | 0 | 0 |
| Carb 872 | HFC-55 | 687 | 0.25254 | 100 | 0 | 0 |
| Carb 873 | HFC-55 | 739 | 0.27075 | 100 | 0 | 0 |
| Carb 868 | fructose | 804 | 0.28088 | 100 | 0 | 0 |
| Carb 869 | glucose | 733 | 0.25153 | 100 | 0 | 0 |
| Carb 870 | fructose | 581 | 0.20903 | 100 | 0 | 0 |
| Carb 871 | glucose | 640 | 0.23571 | 100 | 0 | 0 |

A series of modified activated carbons were also prepared from selected precursors using the addition of several aromatic compounds. Selected carbohydrates were mixed with several aromatic compounds in an aqueous solution and were subjected to the hydrothermal carbonization process. Surface properties of the resulting modified carbons are given in Table 21 and show that a range of surface area, total pore volume and pore distribution can be obtained by hydrothermally processing a mixture of various carbohydrates and organic additives. The purpose of the additives was to effect changes in the yield, carbon content and surface properties of the resulting activated carbon materials.

TABLE 21
Nitrogen BET surface area, pore volume, and pore
distribution of activated carbon samples prepared
from mixtures of precursors/additives.

| | | BET | TVP | | | |
|---|---|---|---|---|---|---|
| Sample ID | Precursor | (m2/g) | (cc/g) | Micro | Meso | Macro |
| Carb 838 | Bourbon | 1533 | 0.56347 | 96 | 4 | 0 |
| | stillage | | | | | |
| Carb 839 | Bourbon | 784 | 0.2677 | 100 | 0 | 0 |
| | stillage | | | | | |
| Carb 840 | HFCS-55 | 1197 | 0.40725 | 100 | 0 | 0 |
| Carb 841 | HFCS-55 | 1064 | 0.35838 | 100 | 0 | 0 |
| Carb 843 | HFCS-55 | 1334 | 0.46637 | 99.9 | 0.01 | 0 |
| Carb 844 | HFCS-55 | 1353 | 0.48738 | 99.5 | 0.1 | 0.4 |
| Carb 847 | HFCS-55 | 1260 | 0.43774 | 100 | 0 | 0 |
| Carb 850 | HFCS-55 | 983 | 0.33402 | 100 | 0 | 0 |
| Carb 855 | Bourbon | 1746 | 0.75779 | 72 | 28 | 0 |
| | stillage | | | | | |
| Carb 856 | Bourbon | 1537 | 0.68319 | 67 | 31 | 2 |
| | stillage | | | | | |
| Carb 858 | Glucose | 996 | 0.88799 | 39 | 55 | 6 |
| Carb859 | HFCS-55 | 820 | 0.30147 | 100 | 0 | 0 |
| Carb 861 | HFCS-55 | 877 | 0.33463 | 100 | 0 | 0 |
| Carb 862 | Fructose/ | 1029 | 0.39479 | 100 | 0 | 0 |
| | glucose | | | | | |
| Carb 863 | HFCS-55 | 806 | 0.2992 | 100 | 0 | 0 |
| Carb 865 | HFCS-55 | 571 | 0.21432 | 100 | 0 | 0 |
| Carb 866 | HFCS-55 | 795 | 0.31723 | 95 | 4 | 1 |
| Carb 867 | HFCS-55 | 1036 | 0.38965 | 100 | 0 | 0 |

Activated carbon/chloroform adsorption isotherms and parameters. Chloroform (trichloromethane) VOC adsorption experiments were conducted as described in previous reports. To reiterate, results of the VOC adsorption experiments were analyzed using the Freundlich adsorption isotherm equation. The Freundlich adsorption isotherm is commonly used for adsorption capacity calculations and has the following form;

qe=K_{F}Ce^{1/n}

where qe (mg/g) represents the amount of trichloromethane adsorbed (mg) per unit mass of activated carbon (AC), (g), Ce (mg/L) is the concentration of residual trichloromethane in the contaminated water solution after the AC and trichloromethane/water solution reach adsorptive equilibrium and K [(mg/g)(L/mg)1/n] is the Freudlich adsorption capacity parameter and 1/n (unitless) is the Freundlich adsorption intensity parameter. K is an indicator of the adsorption capacity; the higher the K value, the higher the maximum adsorption capacity (qe). The higher the 1/n value, the more favorable is the adsorption. In general, n<1 and 1/n>1. n and K are system specific constants. VOC adsorption data obtained on the activated carbons were plotted as a log-log plot. In general, good data fit well to the Freundlich isotherm model when the R2>0.9 and adsorption is favorable (1/n<1) and is considered a physical process where n>1.

The Freundlich equation shows mathematically the relationship between the amount of impurity (e.g., trichloromethane) and the impurity concentration. When the Freundlich equation is expressed in logarithmic form, the empirical equation becomes a straight line with a slope of i/n and a Y-axis intercept of log KF. The adsorption isotherms provide useful information for estimating the adsorption performance of activated carbons and can be used to predict the relative performance of different types of activated carbons. The position and slope of the adsorption isotherm lines reveal how well one carbon performs relative to another carbon. A higher isotherm line means that carbon has better adsorptive capacity than one with a lower isotherm line. When the isotherm line is nearly horizontal, it means the carbon has good adsorption of impurity throughout a wide range of impurity concentration. A nearly vertical isotherm line shows poor adsorptive properties at lower impurity concentrations.

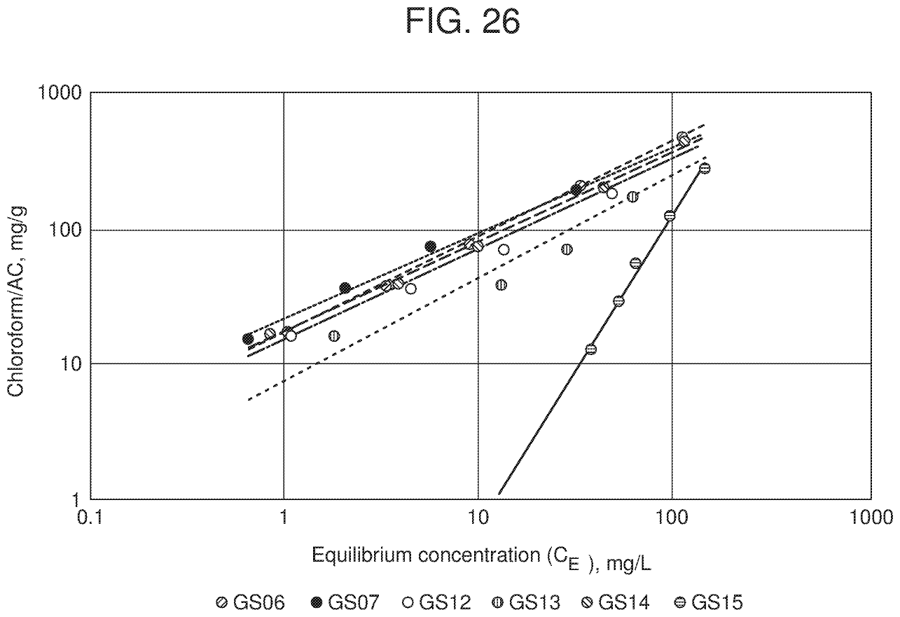

Freundlich isotherms for chloroform adsorption are shown in FIG. 26 for the GS samples obtained (Table 17). In general, all the samples with the exception of GS15 were comparable in terms of their adsorption capacities. GS13 showed slightly lower VOC adsorption capacity than the GS06, 07, 12 and 14 group whereas the chloroform adsorption performance of GS13 was less than its analogue GS14. Interestingly, GS15 showed dramatically poorer adsorption performance when compared to the rest of the activated carbons in the group. Allegedly, samples GS14 and GS15 are analogues and only differ in particle size; GS14 is a powder activated carbon (PAC) while GS15 is a granular activated carbon (GAC), Table 17. The differences in VOC adsorption performance based on particle size is astonishing. According to ASTM classification, powdered activated carbon (PAC) is defined as crushed or ground carbon particles, 95-100% of which can pass through an 80-mesh sieve (0.177 mm) and smaller. On the other hand, granular activated carbon (GAC) has a relatively larger particle size compared to powdered activated carbon and consequently, presents a smaller external surface to volume ratio. GAC is designated by sizes such as 8×20, 20×40, or 8×30 for liquid phase applications with the 12×40 and 8×30 sizes being more popular for aqueous phase applications. For example, a 20×40 carbon is made of particles that can pass through a U.S. Standard Mesh Size No. 20 sieve (0.84 mm) (generally specified as 85% passing) but be retained on a U.S. Standard Mesh Size No. 40 sieve (0.42 mm) (generally specified as 95% retained). A comparison of the samples GS14 and GS15 show that their surface areas, TPV and pore distributions are not that widely different to account for the dramatic difference in VOC adsorption performance. We can suspect that surface area chemistry would have a dramatic effect on VOC adsorption and this could explain some of the disparity observed but cannot account for it entirely.

Freundlich adsorption isotherm data for the GE samples are given in Table 20 and clearly show that sample GS07 to have the highest VOC adsorption efficiency for trichloromethane [22.479 (mg/g)(L/mg)1/n] of all the activated carbons in the group. As already stated, GS15 showed the poorest performance for trichloromethane adsorption for the samples. Within the group, sample GS07 was the best activated carbon obtained from GE Appliances for removing trichloromethane from water.

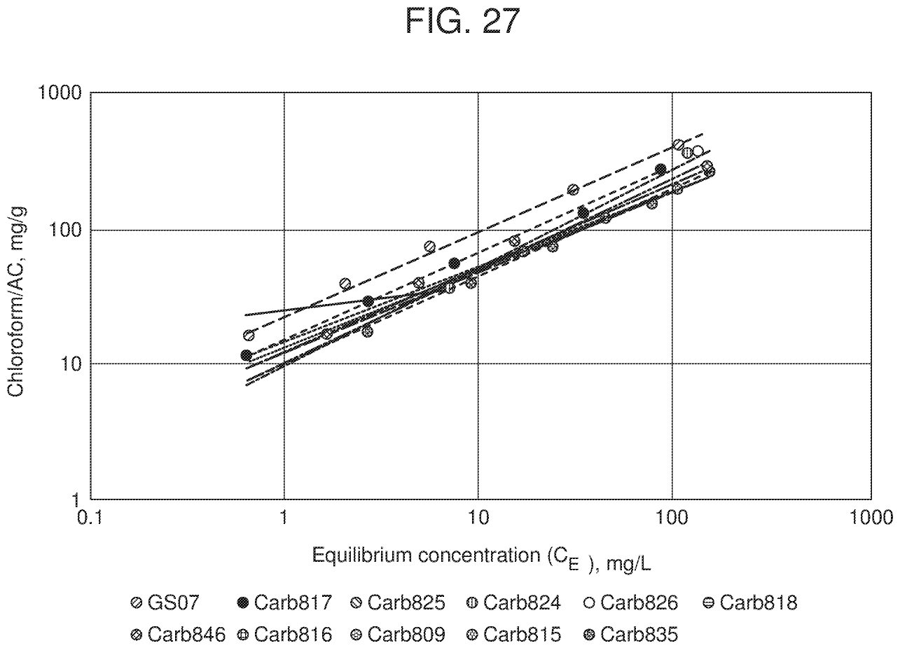

Freundlich isotherms for chloroform adsorption for selected activated carbons prepared from bourbon stillage are presented in FIG. 27. Sample GS07 is also shown for comparison. The adsorption isotherm data show that for the activated carbons prepared from bourbon stillage, sample Carb 817 was the best performing carbon but still not as good as sample GS07. The data also show that for the most part, these materials have similar adsorption performance characteristics. Calculated Freundlich Isotherm parameters for adsorption of trichloromethane in water on activated carbon samples prepared from stillage are presented in Table 22. The data show that sample Carb 849 [16.22 (mg/g)(L/mg)1/n] was the best performing activated carbon followed closely by Carb 817 [15.05 (mg/g)(L/mg)1/n].

TABLE 22
Calculated Freundlich Isotherm parameters for adsorption
of trichloromethane in water on activated carbon samples

| | | | K | |
|---|---|---|---|---|
| Sample ID | 1/n | n | (mg/g)(L/mg)1/n | R2 |
| GS06 | 0.7252 | 1.38 | 16.472 | 0.9989 |
| GS07 | 0.6305 | 1.59 | 22.479 | 0.9948 |
| GS12 | 0.6955 | 1.44 | 13.405 | 0.9899 |
| GS13 | 0.7719 | 1.29 | 7.7417 | 0.9238 |
| GS14 | 0.6697 | 1.49 | 17.294 | 0.9965 |
| GS15 | 2.3344 | 0.428 | 0.0031 | 0.9919 |

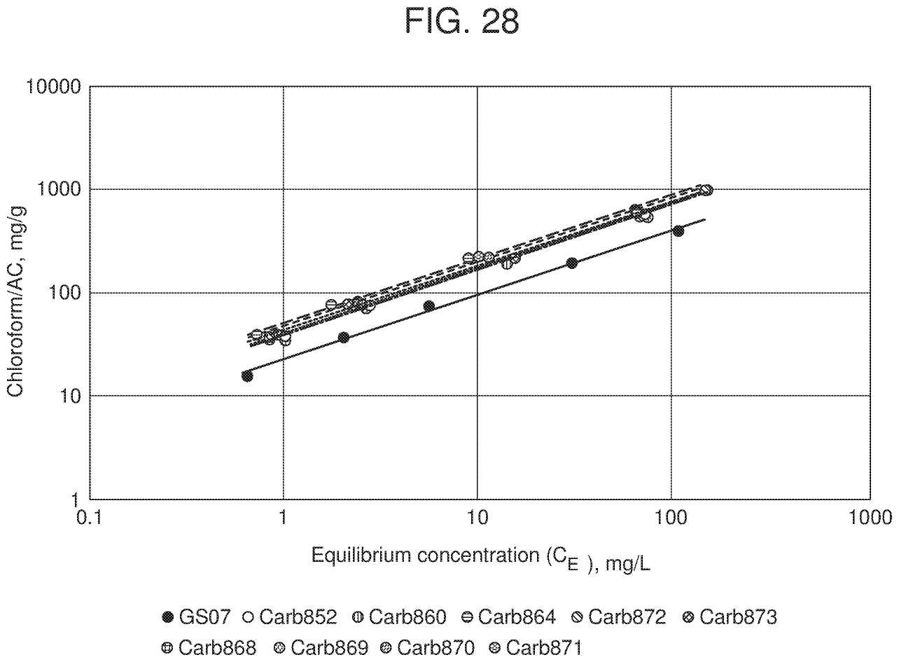

Freundlich isotherms for chloroform adsorption for activated carbons prepared from commercial carbohydrates are presented in FIG. 28 with the corresponding calculated isotherm parameters given in Table 23. Again, sample GS07 is plotted for reference. As mentioned previously, these materials were prepared from either high fructose corn syrup (HFCS) 55 or glucose or fructose alone. As shown clearly in FIG. 28 all of the commercial carbohydrates behave uniformly similar with excellent adsorption properties and surpass the adsorption performance of the best GE material (GS07). Even, the poorest performing carbon in this group, Carb 857 [24.58 (mg/g)(L/mg)^{1/n}] performed slightly better than GS07 [22.48 (mg/g)(L/mg)^{1/n}]. It show also be noted that Carb 857 had the lowest surface area and lowest TPV (0.19498 cc/g) in the group. The best performing carbon in the group was Carb 864 [51.09 (mg/g)(L/mg)^{1/n}].

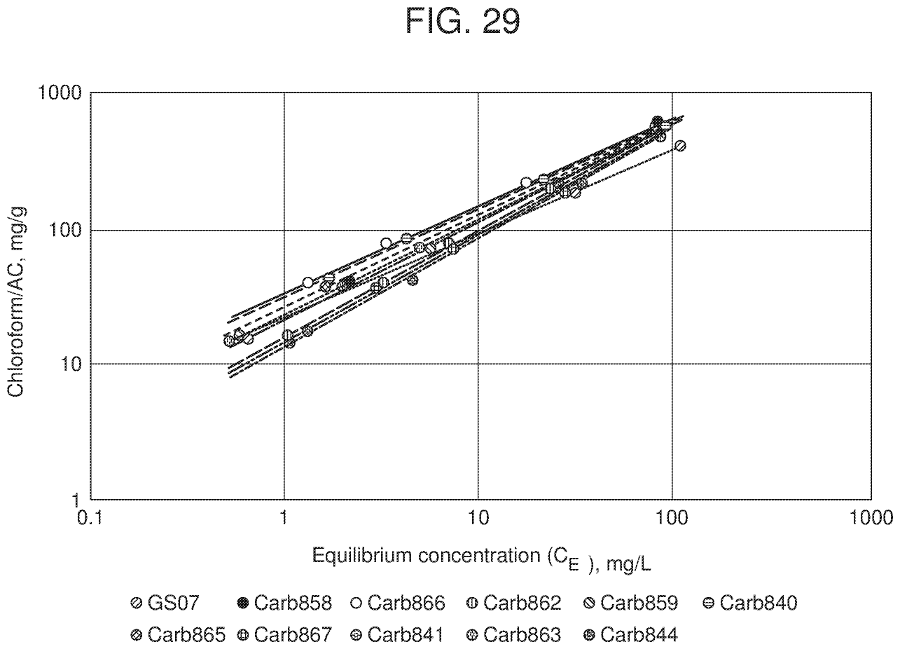

Freundlich isotherms for chloroform adsorption for selected activated carbons prepared from mixtures of precursor and additives are presented in FIG. 29 with corresponding calculated isotherm parameters for all of the activated carbons given in Table 23. As before, GS07 is also plotted as a reference. These data show that there is a range of adsorption performance that can be obtained using various formulations of precursors and additives. In many instances, the adsorption performance of these activated carbons exceeded that of sample GS07 with Carb 866 (prepared from HFCS-55) achieving the best adsorption performance [34.76 (mg/g)(L/mg)1/n] in the group.

Graphical representation of adsorption performance. Adsorption data collected from the Alpha MOS were used to compare graphically various activated carbons within each group for the amount of chloroform removed from a given sample mass of activated carbon. Data (presented as a bar chart) was obtained from spiked water samples containing chloroform at a concentration of 100 mg/L, in which two activated carbon sample masses (5 and 20 mg) were exposed for 24 hours at room temperature. Chloroform concentration was measured by head space gas chromatography using the Alpha MOS in samples before they came into contact with the adsorbent @ t=0 and after a 24 hour exposure to the activated carbons when equilibrium between solution and adsorbent was reached. For each sample, the percentage of chloroform removed from the spiked water was calculated using the following formula:

$$\% Chloroform Removed = \frac{C o - C e}{C o} \times 100$$

where; Co=chloroform concentration at time=0 [mg/L] and Ce=chloroform concentration at equilibrium [mg/L].

TABLE 23
Calculated Freundlich Isotherm parameters for
adsorption of trichloromethane in water on activated
carbon samples prepared from stillage.

| | | | K |
|---|---|---|---|
| Sample ID | 1/n | n | (mg/g)(L/mg)1/n |
| Carb 807 | 0.71 | 1.41 | 8.54 |
| Carb 809 | 0.62 | 1.61 | 12.21 |
| Carb 810 | 0.7 | 1.43 | 8.20 |
| Carb 811 | 0.54 | 1.85 | 9.23 |
| Carb 812 | 0.64 | 1.56 | 12.87 |
| Carb 813 | 0.64 | 1.56 | 12.74 |
| Carb 814 | 0.69 | 1.45 | 9.91 |
| Carb 815 | 0.5747 | 1.74 | 14.08 |
| Carb 816 | 0.586 | 1.71 | 13.12 |
| Carb 817 | 0.6371 | 1.57 | 15.07 |
| Carb 818 | 0.61 | 1.64 | 12.96 |
| Carb 819 | 0.261 | 3.83 | 8.41 |
| Carb 820 | 0.61 | 1.64 | 10.65 |
| Carb 821 | 0.58 | 1.72 | 8.28 |
| Carb 822 | 0.67 | 1.49 | 6.73 |
| Carb 823 | 0.7 | 1.43 | 8.91 |
| Carb 824 | 0.72 | 1.39 | 9.63 |
| Carb 825 | 0.7 | 1.43 | 10.13 |
| Carb 826 | 0.7 | 1.43 | 10.67 |
| Carb 827 | 0.68 | 1.47 | 10.27 |
| Carb 828 | 0.8 | 1.25 | 3.66 |
| Carb 829 | 0.84 | 1.19 | 4.27 |
| Carb 830 | 0.67 | 1.49 | 10.95 |
| Carb 831 | 0.63 | 1.59 | 6.55 |
| Carb 832 | 0.63 | 1.59 | 5.56 |
| Carb 833 | 0.64 | 1.56 | 12.62 |
| Carb 834 | 0.66 | 1.52 | 13.04 |
| Carb 835 | 0.64 | 1.56 | 9.61 |
| Carb 836 | 1.37 | 0.73 | 0.79 |
| Carb 837 | 0.74 | 1.35 | 2.48 |
| Carb 845 | 0.68 | 1.47 | 9.45 |
| Carb 846 | 0.61 | 1.64 | 14.44 |
| Carb 848 | 0.68 | 1.47 | 13.26 |
| Carb 849 | 0.63 | 1.59 | 16.22 |
| Carb 851 | 0.66 | 1.52 | 13.76 |
| Carb 853 | 0.68 | 1.47 | 11.17 |
| Carb 854 | 0.65 | 1.54 | 12.20 |

TABLE 24
Calculated Freundlich Isotherm parameters for adsorption
of trichloromethane in water on activated carbon samples
prepared from commercial carbohydrates

| | | | K |
|---|---|---|---|
| Sample ID | 1/n | n | (mg/g)(L/mg)1/n |
| Carb 852 | 0.62 | 1.61 | 46.98 |
| Carb 857 | 0.66 | 1.52 | 24.58 |
| Carb 860 | 0.63 | 1.59 | 42.06 |
| Carb 864 | 0.62 | 1.61 | 51.09 |
| Carb 872 | 0.63 | 1.59 | 42.08 |
| Carb 873 | 0.63 | 1.59 | 44.77 |
| Carb 868 | 0.62 | 1.61 | 44.61 |
| Carb 869 | 0.61 | 1.64 | 39.77 |
| Carb 870 | 0.64 | 1.56 | 45.35 |
| Carb 871 | 0.63 | 1.59 | 41.58 |

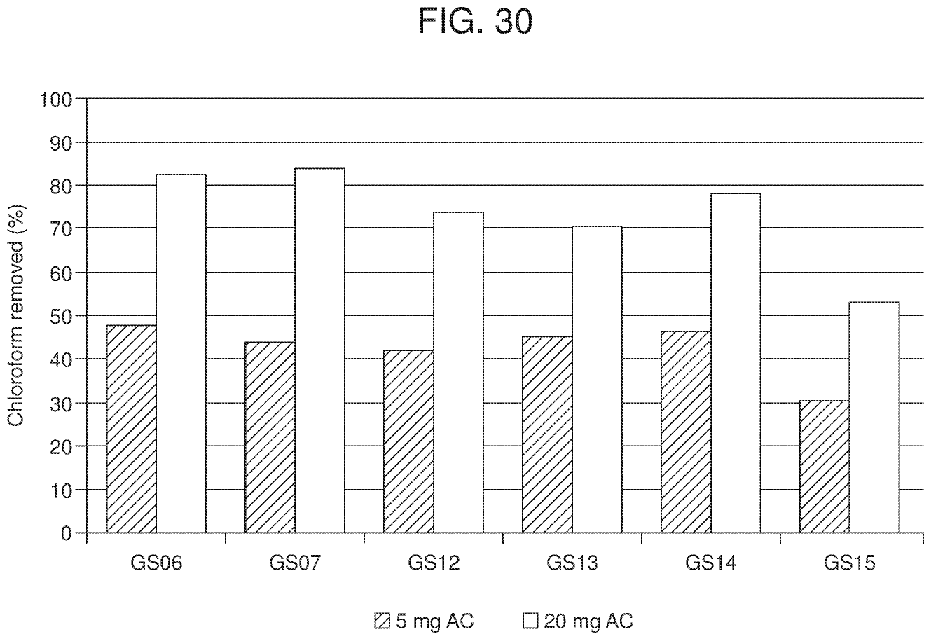

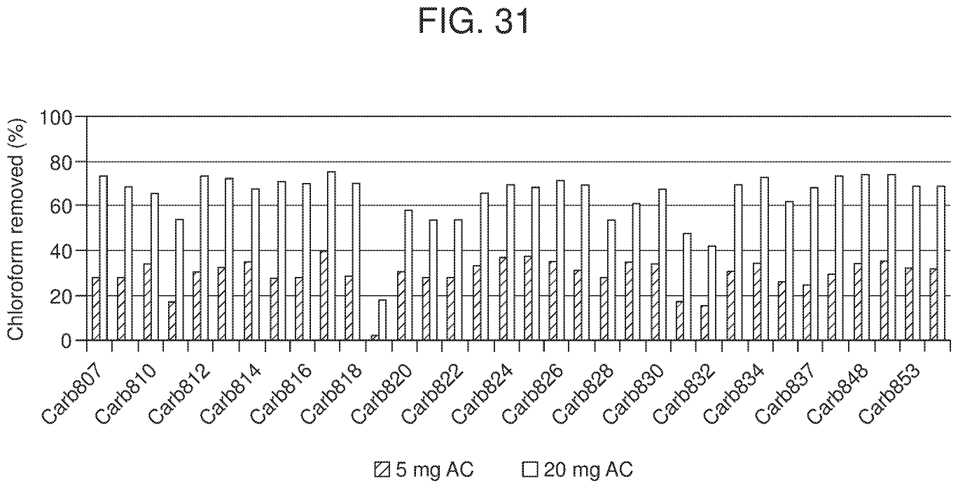

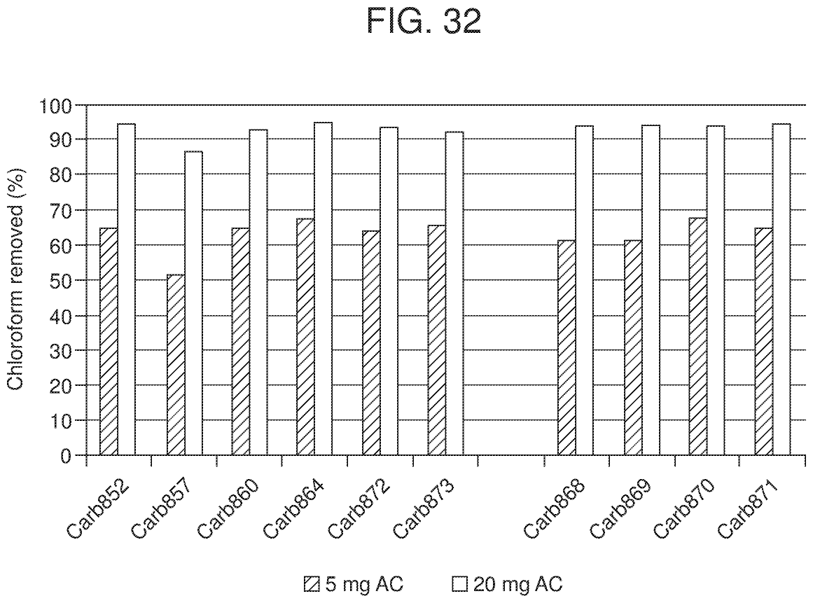

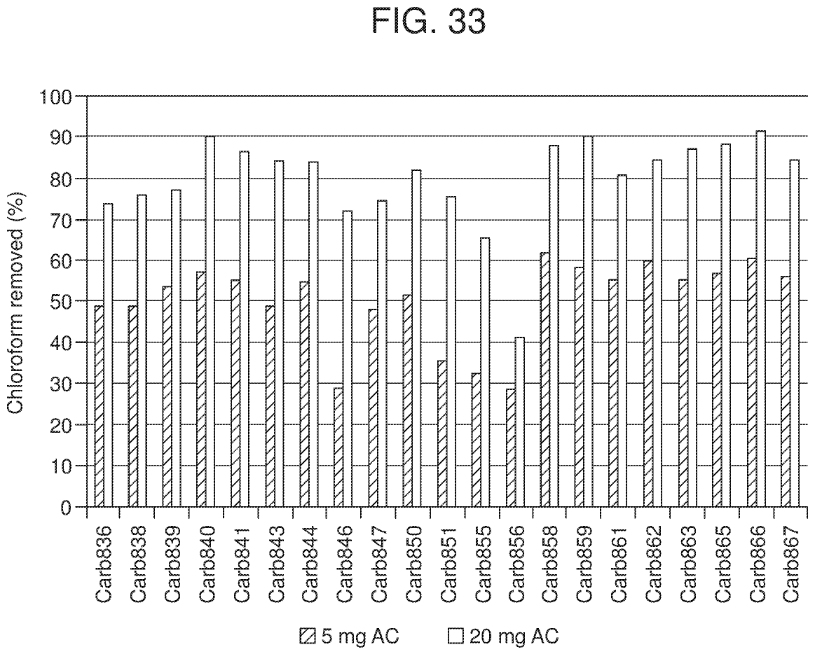

Bar chart data for chloroform reduction of the activated carbons supplied by GE Appliances are presented in FIG. 30 and shows that samples GS06 and GS07 to be the most effective carbon in removing chloroform with over 80% removal using the 20 mg sample size followed by sample GS14. Sample GS15 performed the poorest of the sample group. The data also show that sample GS06 to be the most effective carbon in chloroform removal using the smaller 5 mg sample size. Comparable data for activated carbons prepared from selected bourbon stillage, commercial carbohydrate and precursor/additive mixtures are shown in FIGS. 31, 32 and 33, respectively. Data for the bourbon stillage samples show that these materials are not as effective in chloroform removal as the best GE samples (GS06 and 07) but still have acceptable performance (>75% removal at 20 mg). On the other hand, the data shown for activated carbons prepared from commercial carbohydrates are more effective in removing chloroform (>90% removal at 20 mg and >60% removal at 5 mg) than the best samples supplied by GE Appliances. Finally, most of the activated carbons prepared from the various precursor and additive mixtures were superior to the best GE samples removing well over 80% of chloroform using a 20 mg sample mass. Using the 5 mg sample mass, these activated carbons removed on average over 50% of the chloroform and were again superior to the materials supplied by GE Appliances.

TABLE 25
Calculated Freundlich Isotherm parameters for adsorption
of trichloromethane in water on activated carbon samples
prepared from modified precursor/additives.

| | | | K |
|---|---|---|---|
| Sample ID | 1/n | n | (mg/g)(L/mg)1/n |
| Carb 838 | 0.87 | 1.15 | 5.58 |
| Carb 839 | 0.63 | 1.59 | 20.55 |
| Carb 840 | 0.64 | 1.56 | 32.42 |
| Carb 841 | 0.7 | 1.43 | 23.00 |
| Carb 843 | 0.7 | 1.43 | 18.60 |
| Carb 844 | 0.81 | 1.23 | 13.84 |
| Carb 847 | 0.68 | 1.47 | 17.27 |
| Carb 850 | 0.63 | 1.59 | 23.38 |
| Carb 855 | 0.71 | 1.41 | 8.50 |
| Carb 856 | 0.74 | 1.35 | 6.37 |
| Carb 858 | 0.73 | 1.37 | 22.27 |
| Carb 859 | 0.7 | 1.43 | 26.95 |
| Carb 861 | 0.67 | 1.49 | 20.20 |
| Carb 862 | 0.8 | 1.25 | 16.10 |
| Carb 863 | 0.69 | 1.45 | 23.62 |
| Carb 865 | 0.68 | 1.47 | 26.83 |
| Carb 866 | 0.64 | 1.56 | 34.76 |
| Carb 867 | 0.79 | 1.27 | 14.65 |

Preliminary data for monochloramine removal. Chloramine, or monochloramine (NH2Cl) is compounded from ammonia and chlorine. It is commonly used in low concentrations as a disinfectant in municipal water systems as an alternative to free chlorine. Chloramine has been used by municipal water systems for many decades as its application in these systems continues to increase.

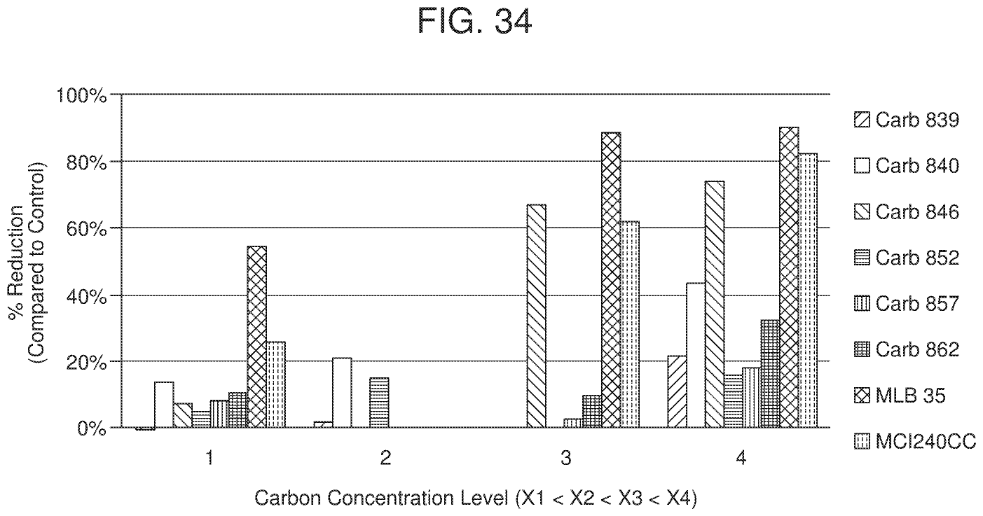

Seven samples of activated carbons were selected to conduct monochloramine removal experiments. In addition to these samples, two samples, GS14 (labelled MLB35) and GS07 (labelled MC1240CC) were also tested under similar experimental conditions. The materials tested for chloramine reduction are presented in Table 26 and lists their surface area and chloroform adsorption properties. The chloramine reduction experiments were conducted with various water/carbon ratios including 10, 25 and 80 mL/g carbon. These are labeled as X1, X2 and X3, etc., respectively in FIG. 34 which shows a comparison of the percent chloramine removal for each of the activated carbon samples. The data reveal that MLB 35 (GS14) to be the best activated carbon for removing chloramine followed by MC1240CC (GS07). It should be noted that each of these activated carbons have been identified as “catalytic carbons” and specifically targeted for chloramine reduction. It is noteworthy to point out that the best performing activated carbon prepared in our lab that was submitted for monochloramine testing was Carb 846, the only material in the group prepared from bourbon stillage.

TABLE 26
Chloramine reduction comparison for selected activated carbons.

| | | BET | TVP | | | | K | |
|---|---|---|---|---|---|---|---|---|
| Sample ID | Precursor | (m2/g) | (cc/g) | Micro | Meso | Macro | (mg/g)(L/mg)1/n | 1/n |
| Carb | Bourbon | 784 | 0.2677 | 100 | 0.0 | 0.0 | 20.55 | 0.63 |
| 839 | stillage | | | | | | | |
| Carb | HFCS-55 + | 1197 | 0.40725 | 100 | 0.0 | 0.0 | 32.42 | 0.64 |
| 840 | additives | | | | | | | |
| Carb | HFCS-55 | 1064 | 0.35838 | 100 | 0.0 | 0.0 | 23.00 | 0.7 |
| 841 | | | | | | | | |
| Carb | Bourbon | 465 | 0.17297 | 100 | 0.0 | 0.0 | 14.44 | 0.61 |
| 846 | stillage | | | | | | | |
| Carb | HFCS-55 | 629 | 0.20935 | 100 | 0.0 | 0.0 | 46.98 | 0.62 |
| 852 | | | | | | | | |
| Carb | HFCS-55 | 532 | 0.19498 | 100 | 0.0 | 0.0 | 24.58 | 0.66 |
| 857 | | | | | | | | |
| Carb | Fructose/ | 1029 | 0.39479 | 100 | 0.0 | 0.0 | 16.10 | 0.8 |
| 862 | glucose + | | | | | | | |
| | additives | | | | | | | |
| MLB35 | AC from | 1347 | 0.53733 | 87 | 12 | 1 | 17.294 | 0.67 |
| (GS14) | GE | | | | | | | |
| MC1240CC | AC from | 958 | 0.3891 | 92 | 7 | 1 | 22.479 | 0.63 |
| (GS07) | GE | | | | | | | |

In order to increase chloramine reduction, it is necessary to modify the carbon surface by creating catalytic sites. Such carbons are referred to as “catalytic carbon”. In general, activated carbon has no significant amount of surface functional groups and it is deficient elements such as O, N, etc. To order to prepare carbons to have an affinity for chloramine reduction, carbon is exposed to nitrogen (N) containing compounds such as ammonia, urea, etc. using a high temperature thermal process, in order to “dope” the carbon matrix with N or enrich the surface of the carbon with N. Under appropriate conditions (e.g., during activation), the carbon matrix can be enriched with specific catalytic species or create catalytic sites in the form of dopant N or functional N-groups. In general, the higher the N content, the higher is the catalytic activity for monochloramine reduction. Monochloramine can be very significantly removed by using catalytically activated (N-enriched) carbon. It should be noted that activated carbon does not adsorb chloramines but rather removes them through its ability to act as a catalyst for the chemical decomposition or conversion of chloramines to innocuous chlorides in water. The theoretical reaction mechanism occurs in the following two-step process:

NH₂Cl+H₂O+C*→NH₃+H⁺+Cl⁻+CO* Step A:

NH₂Cl+CO*→N₂+2H⁺+2Cl⁻+H₂O+C* Step B:

The mechanism shows that the catalytically active sites (C*) on the activated carbon decompose the chloramine molecules which result in the formation of a carbon oxide intermediate (CO*), which further decomposes the molecules into innocuous chlorine.

It should be noted that the two activated carbons, GS14 (labelled MLB35) and GS07 (labelled MC1240CC) used by GE in this experiment are known “catalytic carbons” and are specifically targeted for monochloramine reduction as they have likely been enriched with N through a thermal process. The one activated carbon (Carb 846) prepared in our lab from bourbon stillage was the best performing carbon from the group we supplied. The reason for this is that bourbon stillage can contain nitrogen-containing compounds, including proteins, nucleic acids and chitin and as a result was superior to the rest of activated carbons prepared in our lab and submitted for monochloramine testing. The other activated carbons that we supplied for monochloramine testing were either prepared from fructose and glucose (HFCS-55), none of which contain N. No attempt was made to activate carbons using ammonia or ammonium hydroxide which can be used to enrich the surface of activated carbons with N. In all cases, activation was performed using steam only since it is the lowest cost method for preparing activated carbon.

### CONCLUSIONS

Activated carbons prepared through hydrothermal carbonization from waste materials, like bourbon stillage are very effective in removing both trichloromethane and monochloramine from water.
Activated carbons with high surface area and high pore volume are not required to effectively remove trichloromethane from water.
Activated carbons prepared from the hydrothermal treatment of high fructose corn syrup (e.g., HFCS-55 or derivative) or fructose or glucose alone have the highest adsorption capacity and are superior to all carbons tested in removing trichloromethane from water (including commercial carbons used by GE Appliances).
In general, activated carbons prepared from mixtures of various carbohydrates and organic additives are also superior in removing trichloromethane from water when compared to commercial carbons used by GE Appliances.
Activated carbons prepared from bourbon stillage are better at reducing monochloramine when compared to HFCS-55, glucose or fructose due to the nitrogen containing compounds present in the stillage.
Activated carbons having both high adsorption capacity for trichloromethane and high efficiency for monochloramine reduction can be prepared by mixing the appropriating precursor ingredients (e.g., HFCS+N-rich compounds, etc.) into the hydrothermal carbonization process or activating with reactants such as ammonia gas or ammonium hydroxide.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

1. A loupe-based surgical device for fluorescent and visible light visualization of tissue resection, comprising:
a. at least one loupe housing body with a magnifying lens placed therein to allow a user to view a target tissue area of a subject; and
b. a mounted visualization aid on the housing body, the aid comprising a dual light source, a beam splitter, and a camera, wherein the dual light source and the camera are focused toward the beam splitter and further wherein the dual light source and camera are oriented to substantially the same field of view of the target tissue after passing through the beam splitter.

2. The device of claim 1, further comprising a zoom lens and an optional filter between the camera and the beam splitter.

3. The device of claim 2, wherein the camera is connected to a computer.

4. The device of claim 1, further comprising hinged filters at the viewing end of the loupe housing body.

5. The device of claim 4, wherein the hinged filters also comprises ND filter films.

6. The device of claim 1, wherein the dual light source emits individually or simultaneously visible light and a wavelength of light to excite a fluorescent dye.

7. The device of claim 6, wherein the dual light source is connected to a control unit that is optionally connected to a foot pedal.

8. The device of claim 6, wherein the wavelength of light is selected to excite a fluorescent protein selected from a group consisting of indocyanine 5-ALA, methylene blue, green (ICG), blue fluorescent protein (BFP), Tetramethylrhodamine Isothiocyanate (TRITC), cyan fluorescent protein (CFP), wild-type green fluorescent protein (WTGFP), green fluorescent protein (GFP), fluorescein isothiocyanate, yellow fluorescent protein (YFP), Texas Red (TXRED) and cycanine (CY3.5).

9. The device of claim 1, further comprising a lens between the dual light source and the beam splitter.

10. A method for visualizing tissue resection, comprising:
a. administering a fluorescent dye to a subject receiving tissue resection;
b. placing the device of claim 1 on a surgical user operating on the subject; and
c. operating the camera and the dual light source to allow the surgical user to visualize tissue resection in the subject.
